(19) United States
(12) Patent Application Publication
(10) Pub. No.: US 2021/0167463 A1
(43) Pub. Date: Jun. 3, 2021

(54) POLYMER-CERAMIC HYBRID SEPARATOR MEMBRANES, PRECURSORS, AND MANUFACTURING PROCESSES

(71) Applicants: Cornell University, Ithaca, NY (US); AXIUM IP, LLC, San Diego, CA (US)

(72) Inventors: Soshana SMITH, San Diego, CA (US); Joseph M. CARLIN, San Diego, CA (US); Kyoung Woo KIM, San Diego, CA (US); Yong Lak JOO, Ithaca, NY (US)

(21) Appl. No.: 17/046,732

(22) PCT Filed: Apr. 11, 2019
(86) PCT No.: PCT/US2019/026954

§ 371 Date: Oct. 9, 2020

Related U.S. Application Data
(60) Provisional application No. 62/656,169, filed on Apr. 11, 2018.

(51) Int. Cl. H01M 50/451; H01M 10/0525; H01M 50/403; H01M 50/491; C08L 79/08

(52) U.S. Cl. CPC H01M 50/451; H01M 10/0525; H01M 2004/027; H01M 50/491; C08L 79/085; H01M 50/403

(57) ABSTRACT

Provided herein are polymer-ceramic hybrid membranes, as well as processes for manufacturing such membranes. In particular, polymer-ceramic hybrid membranes are non-flammable and thermally stable and may be used in batteries, such as lithium ion batteries.

### CROSS-REFERENCE

This patent application claims the benefit of U.S. Provisional patent Application Ser. No. 62/656,169, filed Apr. 11, 2018, which is incorporated herein by reference in its entirety.

### BACKGROUND OF THE INVENTION

Batteries comprise one or more electrochemical cell, such cells generally comprising a cathode, an anode and an electrolyte. Lithium ion batteries are high energy density batteries that are fairly commonly used in consumer electronics and electric vehicles. In lithium ion batteries, lithium ions generally move from the negative electrode to the positive electrode during discharge and vice versa when charging. In the as-fabricated and discharged state, lithium ion batteries often comprise a lithium compound (such as a lithium metal oxide) at the cathode (positive electrode) and another material, generally carbon, at the anode (negative electrode).

The commercial importance of battery safety has recently become critically clear in the wake of many recent lithium ion battery fires and explosions. Commercial airline carriers, shippers, and others have taken to prohibiting the transport of certain lithium ion batteries and consumer electronics devices using lithium ion batteries. As year-over-year lithium ion battery capacity improvements have failed to keep up with demand, many battery companies have become aggressive in their attempts to improve capacity, sometimes at the expense of safety. For example, according to the New York Times, Samsung's recent difficulties with their consumer electronic lithium ion batteries have resulted from design flaws because of their “aggressive design decisions, which made problems more likely.” In particular, “[i]n the Note 7, Samsung opted for an exceptionally thin separator in its battery” in order to increase active material loading in the battery and, thereby, increase battery capacity. Because of the extremely thin nature of the separator, a much greater likelihood of failure was likely “if it breaks down, varies in thickness or is damaged by outside pressure.”.

### SUMMARY OF THE INVENTION

Provided herein are safe, high-performance battery separators, as well as processes for manufacturing the same. In specific instances, battery separators provided herein are thermally stable (e.g., up to temperatures of 200° C., up to 250° C., or higher). In some instances, battery separators provided herein are flame resistant (e.g., having a limiting oxygen index (LOI) of at least 21%, at least 25%, or higher). In certain embodiments provided herein are separators and separator materials, having good or improved performance characteristics, while also having good safety characteristics. In some embodiments, separators and separator materials provided herein have good or improved mechanical performance characteristics (e.g., decreases failure rate during compression and/or overheating), rate capabilities (e.g., increases rate of charging), wettability (e.g., which further reduces the amount of non-active material required in a battery), and other features, such as relative to commercial materials (e.g., allowing for good or improved capacity and/or capacity retention). In certain embodiments, such materials described herein are produced or producible by a process provided herein. Moreover, in certain embodiments, such materials enable such safety profiles, while also exhibiting excellent performance parameters, such as providing cells with excellent capacities, capacity retention, and rate capabilities.

In certain embodiments, provided herein is a process of producing a battery separator membrane, or precursor thereof. In some embodiments, a process herein comprises providing a nanofiber mat, and depositing a ceramic precursor thereon (e.g., throughout the nanofiber mat, or on one or more surface of the nanofiber mat), such as forming a precursor membrane (e.g., comprising a nanofiber mat where nanofiber segments thereof are at least partially coated with ceramic precursor). In certain instances, the ceramic precursor is cured to form a ceramic. In specific instances, the ceramic precursor is cured by any suitable process, such as by using thermal treatment (e.g., to temperatures of about 250° C. to about 350° C.), by ultraviolet (UV) radiation, other radiation, chemical treatment, or any other suitable process. In some instances, the nanofiber mat is heated (e.g., prior to curing), such as to stabilize and/or partially cure the ceramic precursor (e.g., to allow handling of the precursor membrane, which may otherwise be too sticky to manipulate). In certain instances, the nanofiber mat is calendered (e.g., comprising the application of pressure to the nanofiber mat concurrently or in stages, such as with a stamp press and/or a roll press). In some instances, the calendaring is a heated calendaring, such as to combine the thermal treatment or curing step with the calendaring step.

In certain embodiments, the ceramic precursor is electrosprayed onto a nanofiber mat provided herein. In specific embodiments, provided herein is a process for manufacturing a thermally stable, flame-resistant polymer-ceramic battery separator membrane, the process comprising:
providing a nanofiber mat, the nanofiber mat comprising one or more nanofiber, the one or more nanofiber each comprising a continuous matrix of (e.g., thermally stable, non-flammable) polymer;
depositing ceramic precursor or a fluid stock comprising ceramic precursor on the nanofiber mat forming a coated precursor membrane; and
curing the coated precursor membrane.

In specific embodiments, the fluid stock is applied to the nanofiber mat using a spray technique, such as electrospray. In more specific embodiments, the fluid stock is applied to the nanofiber mat using gas-assisted electrospray. In certain instances, electrospray techniques, particularly gas-assisted electrospray techniques, facilitate well-controlled, and highly tunable deposition of ceramic precursor on the nanofiber mat. In some instances, such deposition facilitates good ceramic coverage and formation of nanofiber junctions, such as to provide structural integrity to the nanofiber mat and/or an inert material for interfacing with electrode materials and/or electrolyte. Moreover, such spray techniques are commercially scalable in ways that other techniques, such as dip coating are not. In addition, such techniques allow the use of a controlled amount of ceramic, whereas other techniques, such as dip-coating, are much more limited. Other techniques involving the formation of shelled nanofibers, such as described in U.S. Provisional patent Application No. 62/506,973, which is incorporated herein for such disclosure, are not versatile as such techniques described herein and have limited capabilities. For example, co-spinning thermally stable polymers (e.g., polyimide) with organopolysilazanes can produce shelled nanofibers in some instances, but can be limited to very low concentrations, which may not provide the desired performance benefits described in certain instances herein. For example, at low concentrations (e.g., about 5 wt. % or less) safety and performance characteristics may be insufficient to meet target specifications, but at just slightly higher concentrations (e.g., about 8 wt. % or more), fluid stocks quickly gel, making commercial electrospin manufacturing impractical or impossible. Moreover, with traditional electrospin techniques, separator membranes generally have to be at least 20-25 micron thick because of the generally porous nature and large pore sizes afforded by electrospinning of non-woven nanofiber mats. By contrast, use of the controlled deposition techniques herein facilitate an ability to control pore size and provide high-performance separator membranes without sacrificing cell safety. In some instances, however, such as described herein, excellent performance characteristics are also obtained when co-spinning polymer with ceramic precursor.

In some embodiments, the electrospray steps described herein comprise:
providing the fluid stock to a first inlet of a first conduit of a nozzle apparatus, the first conduit being enclosed along the length of the first conduit by a first wall having an interior surface and an exterior surface, the first conduit having a first outlet;
providing a gas to a second inlet of a second conduit of the nozzle apparatus, the second conduit being enclosed along the length of the second conduit by a second wall having an interior surface, the second conduit having a second outlet, and at least a portion of the second conduit being positioned along and/or in at least partially surrounding relation to the first conduit; whereby a high velocity gas is provided at the second outlet, the high velocity gas having a velocity of at least 0.05 m/s; and
providing a voltage to the nozzle apparatus.

In certain embodiments, a process provided herein comprises:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
providing the fluid stock to a first inlet of a first conduit of a nozzle apparatus, the first conduit being enclosed along the length of the first conduit by a first wall having an interior surface and an exterior surface, the first conduit having a first outlet;
providing a gas to a second inlet of a second conduit of the nozzle apparatus, the second conduit being enclosed along the length of the second conduit by a second wall having an interior surface, the second conduit having a second outlet, and at least a portion of the second conduit being positioned along and/or in at least partially surrounding relation to the first conduit; whereby a high velocity gas is provided at the second outlet, the high velocity gas having a velocity of at least 0.05 m/s;
providing a voltage to the nozzle apparatus;
collecting a ceramic precursor composition on the nanofiber mat (e.g., forming precursor membrane comprising nanofiber mat coated with ceramic precursor, which may or may not be partially cured);
curing the ceramic precursor and/or thermally treating the nanofiber mat (e.g., precursor membrane); and
calendering the nanofiber mat (e.g., precursor membrane) (e.g., before, after, and/or concurrently with thermal treatment).

In some embodiments, a process provided herein comprises:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
electrostatically charging the fluid stock;
injecting the (e.g., electrostatically charged) fluid stock into a gas stream (e.g., using a nozzle apparatus configured to inject the fluid stock into the gas stream), the gas stream having a velocity of at least 0.05 m/s;
collecting a ceramic precursor composition on the nanofiber mat (e.g., forming precursor membrane comprising nanofiber mat coated with ceramic precursor, which may or may not be partially cured);
curing the ceramic precursor and/or thermally treating the nanofiber mat (e.g., precursor membrane); and
calendering the nanofiber mat (e.g., precursor membrane) (e.g., before, after, and/or concurrently with thermal treatment).

In some embodiments, a process provided herein comprises:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
electrostatically charging the fluid stock;
injecting the fluid stock into a gas stream (e.g., using a nozzle apparatus configured to inject the fluid stock into the gas stream), the gas stream having a velocity of at least 0.05 m/s;
collecting a ceramic precursor composition on the nanofiber mat (e.g., forming precursor membrane comprising nanofiber mat coated with ceramic precursor, which may or may not be partially cured);
curing the ceramic precursor and/or thermally treating the nanofiber mat (e.g., precursor membrane); and
calendering the nanofiber mat (e.g., precursor membrane) (e.g., before, after, and/or concurrently with thermal treatment).

In certain embodiments, provided herein is a process comprising:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
electrostatically charging the fluid stock;
injecting the fluid stock into a gas stream (e.g., using a nozzle apparatus configured to inject the fluid stock into the gas stream), the gas stream having a velocity of at least 0.05 m/s;
collecting a coating composition on the nanofiber mat forming a coated nanofiber mat (e.g., precursor membrane);
thermally treating the coated nanofiber mat (e.g., precursor membrane); and
calendering the coated nanofiber mat.

In certain embodiments, a nozzle provided in a process described herein is an electrospray nozzle, such as a gas-assisted electrospray nozzle. As discussed herein, such electrospray processes provide good control of the depositions provided thereby. In some instances, electrospray processes herein provide a very fine, uniform mist that provides well-dispersed, uniform and controlled depositions (e.g., control of particle/droplet size provides control of deposition domains/particles).

In certain instances, whereupon a fluid stock is ejected from an electrospray nozzle, such as described herein, an aerosol or plume is provided, the aerosol or plume comprising a plurality of plume particles. In some instances, individual plume particles may or may not comprise the liquid medium of the fluid stock. In particular, plume particles closer to the collection substrate comprise less fluid stock than plume particles near the nozzle (e.g., as fluid stock can evaporate as the particles move closer to the collection substrate). In specific embodiments, the plurality of plume particles within d/4 of the collection substrate (e.g., the nanofiber mat) have an average dimension of about 1 micron or less, wherein d is the shortest distance between the first outlet of the nozzle and the substrate. In more specific embodiments, the plurality of plume particles within d/4 of the substrate having an average dimension of about 0.5 micron or less.

In certain embodiments, a ceramic precursor or fluid stock comprising a ceramic precursor is deposited on a nanofiber mat. In some embodiments, wherein the ceramic precursor or fluid stock comprising the ceramic precursor is sprayed onto the nanofiber mat, the ceramic precursor or fluid stock comprising the ceramic precursor is sprayed from a nozzle, such as described herein, wherein a nozzle outlet (e.g., ejecting the precursor material) is configured in opposing relation to the nanofiber mat (e.g., a surface thereof). In certain embodiments, a nanofiber mat forms a two-dimensional membrane comprising a first surface and a second surface and having a thickness of about 25 micron or less. In some instances, one surface of the membrane is configured in opposing relation to an outlet of a spray nozzle described herein.

In some embodiments, deposition of a ceramic precursor on a nanofiber, such as using a process described herein produces a nanofiber mat coated with ceramic precursor. In specific instances, the nanofiber mat comprises one or more nanofibers comprising a continuous polymer matrix. Moreover, as discussed herein, in some instances, the nanofiber mat has a first membrane surface and a second membrane surface, wherein a first portion of the one or more nanofiber(s) is at and in proximity to the first membrane surface, a second portion of the one or more nanofiber(s) is at and in proximity to the second membrane surface, and a third portion of the one or more nanofiber(s) is configured between the first and second membrane surfaces. In some instances, upon deposition of the ceramic precursor, the first portion of the one or more nanofiber(s) comprises one or more coated nanofiber segment(s), the one or more coated nanofiber segment(s) comprising a continuous coating material, the continuous coating material comprising a ceramic precursor and/or a partially cured ceramic precursor, and the continuous matrix of polymer forming a continuous core material of the coated nanofiber segment(s). In certain instances, curing of the ceramic precursor produces a similarly described membrane comprising nanofiber segments shelled with ceramic, more details of which are provided herein.

In certain embodiments, a portion or domain (e.g., comprising a ceramic coating and/or ceramic junctions, such as deposited on a nanofiber mat or membrane via an electrospray process described herein) of the membrane or nanofiber mat extends any suitable amount away from the surface of the membrane or mat, such as about up to the midpoint between the surface (i.e., up to 50% of the way through the membrane, such as up to about 40% of the way through the membrane, up to about 30% of the way through the membrane, up to about 20% of the way through the membrane, or the like. In certain embodiments, the portion or domain (e.g., coated with ceramic) extends at least 2% of the way through the membrane, at least 5% of the way through the membrane, at least 10% of the way through the membrane, or the like. In specific embodiments, the portion or domain extends up to about 10 micron away from the relevant surface, such as about 0.1 micron to about 10 micron. In specific embodiments, the portion or domain extends about 0.5 micron to about 5 micron away from the relevant surface.

In certain embodiments, the nanofiber mat is configured or positioned on a substrate material during deposition of the precursor thereon. In some instances, processes provided herein facilitate high throughput manufacturing of membranes described herein. For example, in some instances, the processes herein are readily configured for roll-to-roll manufacturing. In some embodiments, the nanofiber mat is configured with, is associated with and/or is affixed to a roll-to-roll-conveyor system.

In specific embodiments, an electrospray nozzle provided herein comprises a first conduit (e.g., for fluid stock) and a second conduit (e.g., for pressurized/high pressure gas), wherein the (shortest) average distance between a wall of the first conduit and a wall of the second conduit is about 0.05 mm to about 30 mm. In more specific embodiments, the conduit gap is about 0.05 mm to about 20 mm. In still more specific embodiments, the conduit gap is about 0.1 mm to about 10 mm.

In some embodiments, gas and fluid stock are ejected from a nozzle provided herein in a substantially parallel direction (e.g., within 15 degrees, within 10 degrees, within 5 degrees, or the like). In certain embodiments, the inner surface of the outer walls defining the first and second conduit are within 15 degrees of parallel of one another for at least a portion of the length of the first and second conduits ((e.g., the length of the portion of the nozzle wherein the first and second conduits are within 15 degrees of parallel of one another being the conduit overlap length). In specific embodiments, the inner surface of the outer walls defining the first and second conduit are within 5 degrees of parallel of one another for at least a portion of the length of the first and second conduits (e.g., the length of the portion of the nozzle wherein the first and second conduits are within 5 degrees of parallel of one another being the conduit overlap length). In certain embodiments, the ratio of the conduit overlap length to the first diameter is about 1 or more (e.g., about 2 or more, about 3 or more, about 5 or more, about 1 to about 10).

Any suitable polymer is utilized in the processes or products provided herein. In general, spinnable, thermally stable, and/or non-flammable polymers are preferred. In specific embodiments, non-flammable polymers are utilized. In specific embodiments, the polymer has a limiting oxygen index (LOI) (the minimum concentration of oxygen, expressed as a percentage, that will support combustion of polymer) of at least 21%. In more specific embodiments, the polymer has a limiting oxygen index (LOI) of at least 25%. In still more specific embodiments, the polymer has a limiting oxygen index (LOI) of at least 30%. In yet more specific embodiments, the polymer has a limiting oxygen index (LOI) of at least 35%. In some embodiments, the polymer is thermally stable (e.g., having less than 5 wt. % loss, less than 3 wt. % loss, or less than 1 wt. % loss at 200 C (e.g., held for at least 1 minute)).

In specific embodiments, provided herein the polymer is a polyimide (PI). In more specific embodiments, the polymer is a polyimide (PI) having an aromatic structure in the backbone thereof. In preferred embodiments, the polyimide is thermally stable and non-flammable (e.g., a P84 polyimide).

In some embodiments, the polymer is a polyimide (PI) comprising a radical or repeating unit (e.g., along with other repeat unit(s)) of formula (Ia) in the backbone thereof:

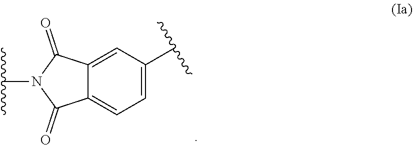

In some embodiments, the polymer is a polyimide (PI) comprising a radical or repeating unit (e.g., along with other repeat unit(s)) of formula (Ib) in the backbone thereof:

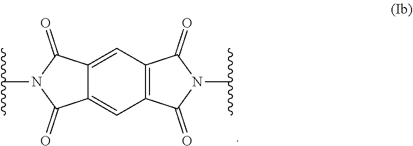

In certain embodiments, the polymer is a polyimide (PI) comprising a radical or repeating unit (e.g., along with other repeat unit(s)) of formula (II) in the backbone thereof:

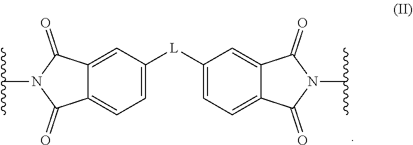

In some embodiments, each L is any suitable linker unit. In specific embodiments, each L independently absent, carboxy, or alkyl. In more specific embodiments, each L independently absent or carboxy.

In certain embodiments, the polymer is a polyimide (PI) comprising a radical or repeating unit (e.g., along with other repeat unit(s)) of formula (III) in the backbone thereof:

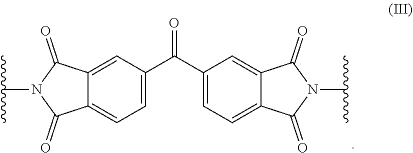

In some embodiments, the polymer is a polyimide (PI) comprising a radical or repeating unit (e.g., along with other repeat unit(s)) of formula (IVa):

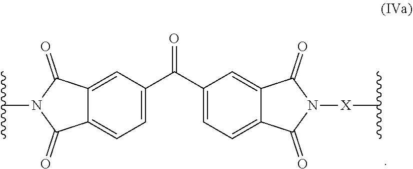

In some embodiments, the polymer is a polyimide (PI) comprising a radical or repeating unit (e.g., along with other repeat unit(s)) of formula (IVb):

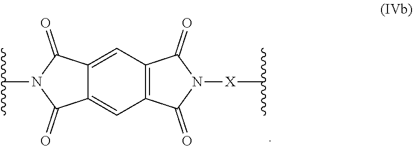

In certain embodiments, each X unit is any suitable linking unit. In specific embodiments, each X is independently a hydrocarbon (e.g., substituted or non-substituted, such as with alkyl, heteroalkyl, aryl, heteroaryl, hydroxyl, halo, carboxy, COOR, OCOR, or the like, such as wherein R is H, alkyl, or heteroalkyl, such as wherein R is alkyl). In more specific embodiments, the hydrocarbon comprises one or more aryl and one or more alkyl group. In still more specific embodiments, the hydrocarbon is (substituted or non-substituted) alkyl, aryl (e.g., as exemplified in Va and Vb), aryl-alkyl, alkyl-aryl, or aryl-alkyl-aryl (e.g., as exemplified in VIa and VIb, wherein L² is alkyl).

In specific embodiments, the polymer is a polyimide (PI) comprising a radical or repeating unit (e.g., along with other repeat unit(s)) of formula (Va). In specific instances, the radical of formula (Va) is the repeating unit of the polymer, comprising n repeat units, wherein n is an integer.

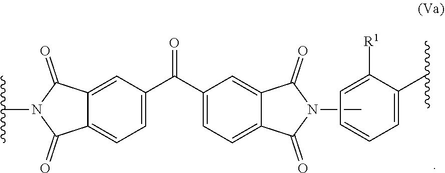

In other specific embodiments, the polymer is a polyimide (PI) comprising a radical of formula (Vb). In specific instances, the radical of formula (Vb) is the repeating unit of the polymer, comprising n repeat units, wherein n is an integer.

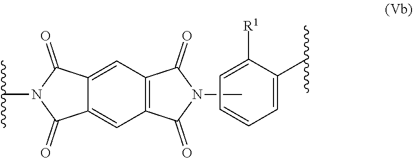

In certain embodiments, the phenyl of the residue of Va is substituted with any R1 at four locations (those locations not attached to the polymer backbone). In specific instances, each R¹ is independently H, alkyl, heteroalkyl, halo, OH, COOR, OCOR, or the like (wherein R is as defined herein). In more specific embodiments, each R¹ is independently H or alkyl.

In other specific embodiments, the polymer is a polyimide (PI) comprising a radical of formula (VIa). In specific instances, the radical of formula (VIa) is the repeating unit of the polymer, comprising n repeat units, wherein n is an integer.

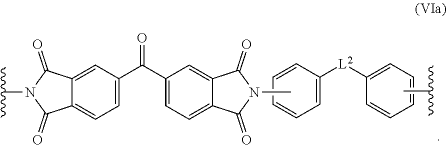

In other specific embodiments, the polymer is a polyimide (PI) comprising a radical of formula (VIb). In specific instances, the radical of formula (VIb) is the repeating unit of the polymer, comprising n repeat units, wherein n is an integer.

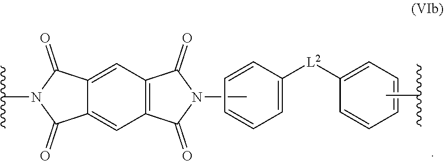

In some embodiments, each L2 is any suitable linker unit. In certain embodiments, each L2 independently absent, —O—, carboxy (>C═O), or alkyl. In specific embodiments, each L2 independently absent, carboxy, or alkyl. In more specific embodiments, each L2 independently absent or alkyl. In certain instances, each L2 is independently substituted or non-substituted, such as with alkyl, heteroalkyl, aryl, heteroaryl, hydroxyl, halo, carboxy, COOR, OCOR, or the like, such as wherein R is H, alkyl, or heteroalkyl, such as wherein R is alkyl.

In some instances, a polymide or polymer provided herein is a co-polyimide, such as a polyimide comprising radicals or repeat units of (i) at least one of formula (Va) and/or formula (Vb), and (ii) at least one of formula (VIa) and/or formula (VIb).

Any suitable ceramic or ceramic precursor is utilized in processes and products provided herein. In some embodiments, the ceramic is a silicon based ceramic (e.g., SiCNO, SiCO, SiCN, SiNO, SiO ceramics). In certain embodiments, the ceramic is a polymer derived ceramic (PDC) (e.g., a ceramic derived from a polysilazane, a poly(organosilazane) (OPSZ), a poly(organosilylcarbodiimide), a poly(organosilsesquioxane), or poly(organosiloxanes)). In specific embodiments, the ceramic is a ceramic derived from a poly(organosilsesquioxane). In addition, any suitable amount of ceramic precursor is utilized in a fluid stock described herein. In some instances, the concentration of ceramic precursor is about 0.1 wt. % to about 20 wt. %, such as about 0.2 wt. % to about 10 wt. %, or about 0.5 wt. % to about 5 wt. %.

In certain instances, ceramic precursor is utilized in any suitable amount, such as in the membranes, fluid stocks and processes herein. In specific embodiments, a ceramic precursor is provided in an amount of about 1 wt. % to about 50 wt. %, relative to the combined weight of precursor and nanofiber mat. In more specific embodiments, ceramic precursor in an amount of about 5 wt. % to about 40 wt. %, relative to the combined weight of precursor and nanofiber mat, is provided.

In certain instances, a fluid stock is sprayed onto a nanofiber mat according to a process described herein. In some instances, the spray technique is a gas assisted spray technique, which facilitates the removal of some or all of the liquid medium of the fluid stock from the aerosol and prior to deposition of ceramic precursor onto the nanofiber mat. In some instances, however, a small amount of liquid medium is deposited (e.g., along with the ceramic precursor) onto the nanofiber mat. In certain embodiments, about 0.1 wt. % to about 10 wt. % (e.g., about 1 wt. % to about 5 wt. %) of the coating composition deposited on the nanofiber mat is a liquid medium (e.g., residual from the fluid stock).

In certain embodiments, provided herein is a thermally stable, flame-resistant polymer-ceramic battery separator membrane. In specific embodiments, the separator membrane comprising a nanofiber mat, the nanofiber mat comprising one or more shelled nanofiber(s). In more specific embodiments, the one or more shelled nanofiber comprises a continuous core material and a continuous shell material (e.g., that runs along the entire length or a part of the length of the nanofiber), the continuous core material comprising a polymer, and the continuous shell material comprising a ceramic.

In certain instances, as described herein, a continuous material is a material that runs continuously along a length (such as from a few microns in length (e.g., >5 micron, >10 micron, >20 micron, or the like), to several microns in length, to the entire length of the fiber) of a nanofiber or nanofiber segment (e.g., at least 5% the length of the nanofiber, at least 10% the length of the nanofiber, at least 25% the length of the nanofiber, at least 50% the length of the nanofiber, at least 75% the length of the nanofiber, or the like), rather than being formed in isolated domains along or within the fiber. In some instances, a continuous material or matrix runs uninterrupted and/or without break along a length of a nanofiber or nanofiber segment herein. In certain instances, a continuous material or matrix is a high aspect ratio material, such as having an aspect ratio of at least 10, at least 20, at least 50, at least 100, at least 200, or the like (e.g., wherein the aspect ratio of the material is the length or the greatest longitudinal dimension divided by the diameter or the greatest lateral dimension).

In some embodiments, provided herein is a separator membrane comprising a nanofiber mat, the nanofiber mat comprising one or more nanofiber, the one or more nanofiber comprising a continuous matrix of polymer, the polymer comprising a polyimide. In specific embodiments, all or part of one or more of the nanofibers is shelled with a continuous shell material, wherein the shell material is a ceramic. In certain instances, the separator membrane is a thermally stable, flame-resistant battery separator material, such as a thermally stable, flame-resistant polymer-ceramic battery separator membrane.

In certain specific embodiments, provided herein is a thermally stable, flame-resistant polymer-ceramic battery separator membrane,
the separator membrane comprising a nanofiber mat, the nanofiber mat comprising one or more nanofiber(s);
the one or more nanofiber(s) comprising a continuous matrix of polymer;
the separator membrane having a first membrane surface and a second membrane surface;
a first portion or domain of the one or more nanofiber(s) being at and in proximity to the first membrane surface, a second portion or domain of the one or more nanofiber(s) being at and in proximity to the second membrane surface, and a third portion or domain of the one or more nanofiber(s) being configured between the first and second membrane surfaces; and
the first portion or domain of the one or more nanofiber(s) comprising one or more shelled nanofiber segment(s), the one or more shelled nanofiber segment(s) comprising a continuous shell material (e.g., in surrounding relation to a continuous core material), the continuous shell material comprising a ceramic, and the continuous matrix of polymer forming a continuous core material of the shelled nanofiber segment(s).

In some embodiments, the first portion or domain of the one or more nanofiber(s) comprises a plurality of nanofiber junctions. In certain instances, a nanofiber junction is a body (e.g., comprising ceramic) joining two or more intersecting nanofiber segment(s). In specific embodiments, the nanofiber junction comprises a ceramic (e.g., same as the ceramic of the shell).

In certain embodiments, a portion or domain of the membrane or nanofiber mat extends any suitable amount away from the surface of the membrane or mat, such as about up to the midpoint between the surface (i.e., up to 50% of the way through the membrane, such as up to about 40% of the way through the membrane, up to about 30% of the way through the membrane, up to about 20% of the way through the membrane, or the like. In certain embodiments, the portion or domain (e.g., coated with ceramic) extends at least 2% of the way through the membrane, at least 5% of the way through the membrane, at least 10% of the way through the membrane, or the like. In specific embodiments, the portion or domain extends up to about 10 micron away from the relevant surface, such as about 0.1 micron to about 10 micron. In specific embodiments, the portion or domain extends about 0.5 micron to about 5 micron away from the relevant surface.

In certain embodiments provided herein, the ceramic concentration of the first portion or domain is higher than the ceramic concentration (e.g., ceramic weight relative to the polymer weight of the domain, or of the overall weight of the domain) of the second domain and/or the third domain. In specific embodiments, the ceramic concentration of the first portion or domain is higher than the ceramic concentration of the second domain. In some embodiments, the ceramic concentration of the first domain is at least 1 percentage point by weight, relative to the polymer weight, higher than the ceramic concentration of the second and/or third domain(s). In specific embodiments, the ceramic concentration of the first domain is at least 2 percentage point by weight, relative to the polymer weight, higher than the ceramic concentration of the second and/or third domain(s). In more specific embodiments, the ceramic concentration of the first domain is at least 5 percentage point by weight, relative to the polymer weight, higher than the ceramic concentration of the second and/or third domain(s).

In certain instances, depending on the process used, the length of spraying, and other variables, ceramic may extend into the separator membrane by varying amounts. In some instances, a first domain (e.g., comprising shelled nanofiber segments) extends at least 0.1 micron into the membrane. In specific embodiments, the first domain extends at least 0.2 micron into the membrane. In more specific embodiments, the first domain extends at least 0.5 micron into the membrane.

In some instances, the second portion or domain of the membrane also comprises shelled nanofiber segments. In specific embodiments, the second portion or domain of the one or more nanofiber(s) comprises one or more second shelled nanofiber segment(s), the one or more second shelled nanofiber segment(s) comprising a continuous shell material, the continuous shell material comprising a ceramic, and the continuous matrix of polymer forming a continuous core material of the second shelled nanofiber segment(s).

In certain embodiments, at least 50% of the polymer (e.g., the polymer core material of nanofibers or segments thereof) of the first domain is covered with a continuous shell material. In specific embodiments, at least 70% of the polymer of the first domain is covered with the continuous shell material. In more specific embodiments, at least 80% of the polymer of the first domain is covered with the continuous shell material. In still more specific embodiments, at least 90% of the polymer of the first domain is covered with the continuous shell material. In yet more specific embodiments, at least 95% of the polymer of the first domain is covered with the continuous shell material. Similar coverage of the second domain polymeric material is also contemplated in those instances wherein the second domain comprises ceramic shelling and/or nanofiber junctions.

Ceramic thickness of a shelled nanofiber or nanofiber segment provided herein is any suitable thickness. In certain embodiments, the average thickness of the shell is about 50% or less of the overall average diameter of the shelled nanofiber or segment thereof. In specific embodiments, the average thickness of the shell is about 30% or less of the overall average diameter. In more specific embodiments, the average thickness of the shell is about 20% or less of the overall average diameter.

In certain embodiments, a membrane provided herein comprises a porous structure. In specific embodiments, the membrane has a porosity of about 10% to about 70%. In certain embodiments, a membrane (e.g., separator membrane) provided herein has a plurality of pores therethrough, wherein fewer than 5% of the pores have a size of less than 1 micron (a pore distribution d95 of less than 1 micron). In specific embodiments, the porous membrane has a pore size distribution d99 of about 1 micron or less. In more specific embodiments, the porous membrane has a pore size distribution d99.9 of about 1 micron or less.

In some embodiments, a membrane provided herein has any suitable thickness. In some instances, nanofiber mats and/or precursor membranes are thicker than separator membranes provided herein (e.g., as the membranes are, in some embodiments, calendered to form a final separator membrane). In specific embodiments, a membrane (e.g., separator membrane) provided herein has an average thickness of about 1 micron to about 25 micron (e.g., about 5 micron to about 15 micron, or about 5 micron to about 10 micron). In preferred embodiments, the average thickness is about 8 to about 20 micron, such as about 12 to about 15 micron.

In certain embodiments, deposition techniques provided herein provide highly uniform coatings, with very small deposition bodies. In some instances, a membrane (e.g., separator membrane) provided herein has a thickness variation of less than 20%. In specific embodiments, the thickness variation is less than 10%. In more specific embodiments, the thickness variation is less than 5%.

As discussed, techniques described herein facilitate the production of highly tunable materials that are capable of having controlled amounts of ceramic, including ceramic at very high levels. In some instances, ceramic of a membrane (e.g., separator membrane) provided herein constitutes about 1 wt. % to about 50 wt. % of the membrane or nanofiber mat thereof. In specific embodiments, ceramic (e.g., of the continuous shell material and nanofiber junctions) constitutes about 3 wt. % to about 30 wt. % of the membrane or nanofiber mat thereof. In more specific embodiments, ceramic (e.g., of the continuous shell material and nanofiber junctions) constitutes about 5 wt. % to about 15 wt. % of the membrane or nanofiber mat thereof. In certain embodiments, polymer constitutes about 50 wt. % to about 99 wt. % of the membrane or nanofiber mat thereof. In specific embodiments, polymer constitutes about 70 wt. % to about 99 wt. % of the membrane or nanofiber mat thereof.

As discussed herein, any suitable polymer is utilized in a membrane or separator membrane provided herein. In some embodiments, the polymer is a non-flammable polymer, such as described herein. In certain embodiments, the polymer is a thermally stable polymer, such as described herein. In specific embodiments, the polymer is a polyimide polymer, such as described herein.

In some embodiments, nanofiber, nanofiber mats, separators, or other membranes provided herein, such as comprising a polyimide and a ceramic, such as derived from a polysilizane (e.g., OPSZ), is thermally treated (such as cured or annealed). In some instances, such treatment facilitates curing of the ceramic and/or polymer. In certain instances, a nanofiber, nanofiber mats, separators, or other membranes provided herein (e.g., of a coated fiber mat and/or a ceramic-polymer hybrid fiber mat prepared directly from electrospinning a combination of polymer (e.g., polyimide) and ceramic precursor) is or has been treated to a temperature of at least 250° C., more preferably, at least 275° C., and still more preferably about 300° C. or more. As demonstrated in the examples, untreated products or products treated at lower temperatures have a greatly reduced resistance to flammability compared to those that are treated at higher temperatures.

In certain embodiments, separator membranes provided herein have good thermal stability, such as having less than 5% weight loss at a temperature of at least 200° C. In specific embodiments, the separator membrane has less than 2% weight loss at a temperature of at least 200° C. In more specific embodiments, the separator membrane has less than 5% weight loss at a temperature of at least 200° C. In certain embodiments, the separator membrane shrinks less than 20% in both the longitudinal and transverse directions upon heating to at least 200° C. In specific embodiments, the separator membrane shrinks less than 2% (e.g., in both the longitudinal and transverse directions) upon heating to at least 200° C. In some embodiments, the separator membrane has a strain of between −20% and +20% (shrinkage/expansion) at a temperature of at least 200° C. and a controlled force of 0.001 N (e.g., in both longitudinal and transverse directions). In specific embodiments, the separator membrane has a strain of between −2% and +2% at a temperature of at least 200 C and a controlled force of 0.001 N (e.g., in both longitudinal and transverse directions).

In certain embodiments, membranes provided herein allow high fluid throughput, facilitating good rate capabilities in battery cells. In some instances, cells comprising a separator provided herein have a capacity retention of at least 85%, at least 90%, at least 95%, or the like after cycling a cell at least 100 cycles at a 2 C charge and discharge rate (e.g., after 1-10, such as 3-5, formation cycles at a slower rate, such as 0.1 C/0.1 C charge/discharge rates). In certain instances, cells comprising a separator provided herein have a capacity retention of at least 85%, at least 90%, at least 95%, or the like after cycling a cell at least 200 cycles at a 2 C charge and discharge rate (e.g., after 1-10, such as 3-5, formation cycles at a slower rate, such as 0.1 C/0.1 C charge/discharge rates). In certain instances, cells comprising a separator provided herein have a capacity retention of at least 75%, at least 80%, at least 85%, at least 90%, or the like after cycling a cell at least 300 cycles at a 2 C charge and discharge rate (e.g., after 1-10, such as 3-5, formation cycles at a slower rate, such as 0.1 C/0.1 C charge/discharge rates).

In certain embodiments, provided herein is a membrane (e.g., separator membrane) having an air permeability of at least 20 mL/s at a differential pressure of 35 pounds per square inch (psi).

Also provided herein are energy storage cells and lithium ion batteries comprising a separator membrane, such as described herein. In some embodiments, provided herein is an energy storage cell comprising a negative electrode, a positive electrode, and a separator membrane of any one of the preceding claims, the separator membrane being configured between the negative electrode and the positive electrode. In certain embodiments, provided herein is a lithium ion battery comprising a negative electrode, a positive electrode, and a separator membrane of any one of the preceding claims, the separator membrane being configured between the negative electrode and the positive electrode.

Also provided herein are membranes comprising nanofibers and a ceramic precursor, which may be partially cured. In certain embodiments, such membranes are precursors to the separator membranes described herein (e.g., wherein curing, heating, and/or calendaring afford the separator membrane).

In some embodiments, provided herein is a nanofiber mat comprising one or more nanofibers comprising a continuous polymer matrix;
the nanofiber mat having a first membrane surface and a second membrane surface;
a first portion of the one or more nanofiber(s) being at and in proximity to) the first membrane surface, a second portion of the one or more nanofiber(s) being at and in proximity to the second membrane surface, and a third portion of the one or more nanofiber(s) being configured between the first and second membrane surfaces; and
the first portion of the one or more nanofiber(s) comprising one or more coated nanofiber segment(s), the one or more shelled nanofiber segment(s) comprising a continuous coating material, the continuous coating material comprising a ceramic precursor and/or a partially cured ceramic precursor, and the continuous matrix of polymer forming a continuous core material of the coated nanofiber segment(s).

In certain instances, porosity of the nanofiber mat or precursor membrane are as described herein for separator membranes, such as wherein the nanofiber mat has a porosity of about 10% to about 70% and/or the maximum pore size as described herein (e.g., d95 of 1 micron or less, d99 of 1 micron or less, d99.9 of 1 micron or less, or the like).

As discussed herein a nanofiber mat or precursor membrane described herein comprising ceramic precursor and/or partially cured ceramic precursor can be thicker than a separator membrane described herein (e.g., as the membrane may be calendered to achieved the thickness desired in the separator membrane described herein. In some embodiments, a nanofiber mat or precursor membrane described herein has a thickness of about 1 micron to about 50 micron, such as about 5 micron to about 50 micron or about 10 micron to about 50 micron. In some embodiments, the thickness is about 1 micron to about 25 micron, such as about 10 micron to about 25 micron. In certain embodiments, the nanofiber mat has a thickness variation of less than 20%, less than 10%, less than 5% or the like.

As with the separator membrane, a nanofiber mat or precursor membrane provided herein comprises, in some embodiments, first portion or domain of the one or more nanofiber(s) comprising a plurality of nanofiber junctions, each nanofiber junction joining two or more intersecting nanofiber segment(s) of the first domain. In the nanofiber mat or precursor membrane, a nanofiber junction comprises, in some embodiments, a ceramic precursor or partially cured ceramic precursor (e.g., same as the ceramic precursor of the coating).

Likewise, just as in some instances the separator membrane comprises higher concentrations of ceramic at one or more surface of the membrane, in certain instances, a nanofiber mat or precursor membrane provided herein comprises a higher concentration of ceramic precursor and/or partially cured ceramic precursor at one or more surface of the nanofiber mat or precursor membrane (e.g., higher than in the middle of the mat or membrane or the domain configured between the two surfaces thereof). In specific embodiments, the ceramic precursor and/or partially cured ceramic precursor concentration of the first domain is higher than the ceramic precursor and/or partially cured ceramic precursor concentration (e.g., ceramic precursor and/or partially cured ceramic precursor weight relative to the polymer weight of the domain, or of the overall weight of the domain) of the second domain and/or the third domain of the nanofiber mat.

In certain embodiments, the ceramic precursor and/or partially cured ceramic precursor concentration of the first domain of the nanofiber mat or precursor membrane is at least 1 percentage point by weight, relative to the polymer weight, higher than the ceramic precursor and/or partially cured ceramic precursor concentration of the second and/or third domain(s). In specific embodiments, the ceramic precursor and/or partially cured ceramic precursor concentration of the first domain is at least 2 percentage point by weight, relative to the polymer weight, higher than the ceramic precursor and/or partially cured ceramic precursor concentration of the second and/or third domain(s). In more specific embodiments, the ceramic precursor and/or partially cured ceramic precursor concentration of the first domain is at least 5 percentage point by weight, relative to the polymer weight, higher than the ceramic precursor and/or partially cured ceramic precursor concentration of the second and/or third domain(s). The first ceramic precursor comprising domain of the nanofiber mat extends any suitable distance into the nanofiber mat. In specific embodiments, the first domain extends at least 0.1 micron into the mat or precursor membrane. In more specific embodiments, the first domain extends at least 0.2 micron into the mat or precursor membrane. In still more specific embodiments, the first domain extends at least 0.5 micron into the mat or precursor membrane.

In some instances, the second portion or domain of the one or more nanofiber(s) comprises one or more second coated nanofiber segment(s), the one or more second coated nanofiber segment(s) comprising a continuous coating material, the continuous coating material comprising a ceramic precursor and/or partially cured ceramic precursor, and the continuous matrix of polymer forming a continuous core material of the second coated nanofiber segment(s). In various embodiments, such characteristics are selected from any of the characteristics described for the first domain.

In some instances, ceramic precursor and/or partially cured ceramic precursor of a nanofiber mat or precursor separator provided herein (e.g., of the continuous coat material and nanofiber junctions) constitutes about 1 wt. % to about 50 wt. % of the membrane or nanofiber mat thereof. In specific embodiments, ceramic precursor and/or partially cured ceramic precursor of a nanofiber mat or precursor separator (e.g., of the continuous coat material and nanofiber junctions) constitutes about 3 wt. % to about 40 wt. % of the membrane or nanofiber mat thereof. In more specific embodiments, ceramic precursor and/or partially cured ceramic precursor of a nanofiber mat or precursor separator (e.g., of the continuous coat material and nanofiber junctions) constitutes about 5 wt. % to about 25 wt. % of the membrane or nanofiber mat thereof. In certain embodiments, polymer constitutes about 40 wt. % to about 99 wt. % of the membrane or nanofiber mat thereof. In specific embodiments, polymer constitutes about 60 wt. % to about 99 wt. % of the membrane or nanofiber mat thereof.

In various embodiments, any polymer as described herein is provided in the nanofiber mats and precursor membranes described herein.

In certain embodiments, at least 50% of the polymer (e.g., the polymer core material of nanofibers or segments thereof) of the first domain is covered with a continuous coating material. In specific embodiments, at least 70% of the polymer of the first domain is covered with the continuous coating material. In more specific embodiments, at least 80% of the polymer of the first domain is covered with the continuous coating material. In still more specific embodiments, at least 90% of the polymer of the first domain is covered with the continuous coating material. In yet more specific embodiments, at least 95% of the polymer of the first domain is covered with the continuous coating material. Similar coverage of the second domain polymeric material is also contemplated in those instances wherein the second domain comprises ceramic precursor (which may be partially cured) coating and/or nanofiber junctions.

Ceramic precursor coating thickness of a coated nanofiber or nanofiber segment provided herein is any suitable thickness. In certain embodiments, the average thickness of the coating is about 50% or less of the overall average diameter of the coated nanofiber or segment thereof. In specific embodiments, the average thickness of the coating is about 30% or less of the overall average diameter. In more specific embodiments, the average thickness of the coating is about 20% or less of the overall average diameter. In still more specific embodiments, the average thickness of the coating is about 10% or less of the overall average diameter.

In some embodiments, a nanofiber mat provided herein is prepared by an electrospinning process, such as a gas-assisted electrospinning process (e.g., as described herein). In certain embodiments, a nanofiber mat provided herein is used as a battery separator with or without a coating described herein. In specific embodiments, a nanofiber mat provided herein comprises a polymer and a ceramic, such as wherein the polymer is a polyimide (e.g., and, wherein, the ceramic is a ceramic obtained from curing a ceramic precursor, such as described herein (e.g., a ceramic produced from a cured polysilazane, such as cured organopolysilazane). As discussed in certain instances herein, such nanofiber mats are produced by electrospinning a mixture of polymer and ceramic precursor. In specific instances, high concentrations of ceramic precursor relative to polymer produce undesirable properties, such as gelling of the fluid stock, hindering the electrospinning thereof (e.g., altogether, or after storage for a certain amount of time). In certain embodiments, the ratio of polymer (e.g., polyimide) to ceramic precursor (e.g., polysilazane, such as organopolysilazane (OPSZ)) is about 9:1 or more (e.g., about 9:1 to about 95:5), such as about 92:8 or more (e.g., about 92:8 to about 96:4).

In certain embodiments, a nanofiber or nanofiber mat provided herein comprises a polymer as described in any embodiment herein, such as a polyimide herein (e.g., as described in any one or more of formula Ia, Ib, II, III, IVa, IVb, Va, Vb, VIa, or VIb, or in any specific embodiment thereof described herein). In certain embodiments, a nanofiber or nanofiber mat provided herein comprises a ceramic as described in any embodiment herein, such as a cured polysilazane (e.g., organopolysilazane) ceramic.

In certain embodiments, a nanofiber mat provided herein is prepared by any suitable process, such as by:
providing a fluid stock, the fluid stock comprising a liquid medium and a polymer (e.g., polyimide) (e.g., in a concentration suitable to produce a jet, as opposed to a spray, such as at a concentration of at least 5 wt. %, at least 6 wt. %, at least 8 wt. %, at least 10 wt. %, or the like) and an optional ceramic precursor (e.g., wherein ceramic-polymer hybrid nanofiber mats are desired, the ceramic precursor is included (e.g., wherein the produced nanofiber mat is used as a separator without further ceramic coating) and wherein polymer nanofiber mats are desired, the ceramic precursor is not needed);
providing the fluid stock to a first inlet of a first conduit of a nozzle apparatus, the first conduit being enclosed along the length of the first conduit by a first wall having an interior surface and an exterior surface, the first conduit having a first outlet;
providing a gas to a second inlet of a second conduit of the nozzle apparatus, the second conduit being enclosed along the length of the second conduit by a second wall having an interior surface, the second conduit having a second outlet, and at least a portion of the second conduit being positioned along and/or in at least partially surrounding relation to the first conduit; whereby a high velocity gas is provided at the second outlet, the high velocity gas having a velocity of at least 0.05 m/s; and
providing a voltage to the nozzle apparatus.

In certain embodiments, a nozzle provided in a process described herein (e.g., for producing nanofibers or mats thereof) is an electrospin nozzle, such as a gas-assisted electrospin nozzle. As discussed herein, such electrospin processes provide good control of the depositions provided thereby. In certain instances, the nanofiber mat comprises one or more nanofibers comprising a continuous polymer matrix (e.g., (e.g., co-continuous) core comprising a ceramic and the polymer, the core being at least partially shelled with a ceramic).

In various embodiments herein, an electrospin nozzle is configured as an electrospray nozzle described herein (e.g., except wherein a higher inclusion (e.g., polymer) concentration facilitates jet formation, rather than spray formation upon ejection therefrom). In specific embodiments, an electrospin nozzle provided herein comprises a first conduit (e.g., for fluid stock) and a second conduit (e.g., for pressurized/high pressure gas), wherein the (shortest) average distance between a wall of the first conduit and a wall of the second conduit is about 0.05 mm to about 30 mm. In more specific embodiments, the conduit gap is about 0.05 mm to about 20 mm. In still more specific embodiments, the conduit gap is about 0.1 mm to about 10 mm.

In some embodiments, gas and fluid stock are ejected from a nozzle provided herein in a substantially parallel direction (e.g., within 15 degrees, within 10 degrees, within 5 degrees, or the like). In certain embodiments, the inner surface of the outer walls defining the first and second conduit are within 15 degrees of parallel of one another for at least a portion of the length of the first and second conduits ((e.g., the length of the portion of the nozzle wherein the first and second conduits are within 15 degrees of parallel of one another being the conduit overlap length). In specific embodiments, the inner surface of the outer walls defining the first and second conduit are within 5 degrees of parallel of one another for at least a portion of the length of the first and second conduits (e.g., the length of the portion of the nozzle wherein the first and second conduits are within 5 degrees of parallel of one another being the conduit overlap length). In certain embodiments, the ratio of the conduit overlap length to the first diameter is about 1 or more (e.g., about 2 or more, about 3 or more, about 5 or more, about 1 to about 10).

In certain embodiments, provided herein are process for preparing polymer-ceramic nanofibers, as well as such nanofibers. In specific instances, polymer-ceramic nanofibers provided herein comprise a continuous core material and a continuous shell material. In certain embodiments, the core material comprises co-continuous materials, including a continuous polymer material and a continuous ceramic material. In some embodiments, the shell material comprises a ceramic. In specific embodiments, the polymer is a thermally-stable, non-flammable polymer material, such as a polyimide described herein. In some embodiments, the ceramic is any ceramic provided herein, particularly a ceramic derived from an organopolysilazane (OPSZ). In certain embodiments herein, such nanofibers are arranged in a nanofiber mat or membrane, such as a separator membrane, which can be used according to the descriptions for separator membranes herein.

In some embodiments, a polymer-ceramic nanofiber is prepared by (i) providing fluid stock comprising a ceramic precursor and a polymer; and (ii) electrospinning the fluid stock. In specific embodiments, the fluid stock is electrospun in a gas-assisted manner (e.g., in the presence of a high velocity gas, such as described for the electrospray processes herein). In certain instances, the process of electrospinning is achieved using any process described herein for electrospray, with the exception that the fluid stock comprises sufficient polymer concentration to generate a fibrous jet, which continues to a collector, rather than disrupting into an aerosol or plume prior to collection on a substrate. In certain instances, polyimide contents of a fluid stock are in any suitable amount, such as about 5 wt. % to about 25 wt. % of the fluid stock, such as about 10 wt. % to about 20 wt. %. As discussed in the examples herein, certain difficulties arise in electrospinning such polyimides in the presence of ceramic precursors, such as gelling solutions, clogging of electrospin nozzles, and/or sticky, unmanageable nanofiber mats. In certain embodiments, a fluid stock provided herein comprises ceramic precursor (e.g., OPSZ) in a polymer to precursor weight to weight ratio of about 80:20 to about 99:1. In specific embodiments, the ratio is about 90:10 to about 95:5. In more specific embodiments, the ratio is about 92:8 to less than 95:5. In some embodiments, ceramic precursor concentration in the fluid stock is about 1 wt. % to about 12 wt. %, such as about 8 wt. % to about 11 wt. %.

In some instances, during electrospinning, ceramic precursor and polymer self-assemble into a core/shell structure, wherein the core comprises a continuous polymer and the shell comprises a ceramic and/or ceramic precursor shell. In some instances, the ceramic precursor partially or completely cures during the electrospinning process. In certain embodiments, collected nanofiber is thermally treated or otherwise cured (e.g., to cure, finish curing, or ensure sufficient curing) of the ceramic precursor.

Provided in various embodiments herein, any nanofiber mat is utilized in a battery separator system as described herein. In some specific embodiments, the nanofiber mat comprises one or more nanofiber, the one or more nanofiber comprising a polymer. As discussed in certain embodiments herein, such a nanofiber mat is coated with a ceramic, such as according to the processes described herein. In some embodiments, the nanofiber mat comprises both ceramic and polymer prior to coating. In other embodiments, such nanofiber mats are optionally utilized as a separator without coating described herein. However, as discussed herein, manufacture of such materials is limited in ways that the coated nanofiber mats described herein are not.

In specific embodiments, provided herein is a nanofiber mat (e.g., used in a battery separator with or without a coating as described herein), the nanofiber mat comprising one or more nanofiber, the nanofiber mat and/or the nanofiber(s) of the one or more nanofiber comprising a polymer in an amount of about 88 wt. % to about 95 wt. % and a ceramic in an amount of about 5 wt. % to about 12 wt. %. In specific embodiments, the polymer is a polyimide (e.g., any polyimide described herein) and the ceramic being a ceramic derived from a polysilizane (e.g., organopolysilizane). In certain embodiments, the nanofiber(s) comprise a core and a ceramic shell, the ceramic shell comprising a portion of the nanofiber ceramic and covering at least 50% (e.g., at least 60%, at least 70%, at least 80%, at least 90%, or the like) of the nanofiber core (or surface thereof). In some embodiments, the nanofiber core comprises polymer and a second portion of the nanofiber ceramic. In the instances of battery separators, such nanofiber mats are thin, such as wherein the nanofiber mat or battery separator has an average thickness of about 5 micron to about 25 micron, such as about 5 micron to about 20 micron, about 5 micron to about 15 micron, or the like.

In certain embodiments the nanofiber mat and/or the nanofiber(s) thereof comprise a polymer in an amount of about 90 wt. % to about 95 wt. % and a ceramic in an amount of about 5 wt. % to about 10 wt. %. In specific embodiments, the nanofiber mat and/or nanofiber(s) thereof comprise polymer in an amount of about 91 wt. % to about 93 wt. % and a ceramic in an amount of about 7 wt. % to about 9 wt. %.

In certain embodiments, the core comprises a continuous polymer matrix (e.g., comprising the polymer) (e.g., running along at least a portion of the nanofiber, such as at least 30% the length of the nanofiber, at least 50% the length of the nanofiber, at least 70% the length of the nanofiber, or the like). In certain embodiments, the core comprises a continuous ceramic matrix (e.g., comprising ceramic, such as a non-shell portion of the nanofiber ceramic content) (e.g., running along at least a portion of the nanofiber, such as at least 30% the length of the nanofiber, at least 50% the length of the nanofiber, at least 70% the length of the nanofiber, or the like). In specific preferred embodiments, the core comprises co-continuous ceramic and polymer, such as wherein each of the ceramic and the polymer run along at least a portion of the nanofiber, such as at least 30% the length of the nanofiber, at least 50% the length of the nanofiber, at least 70% the length of the nanofiber, or the like. Similarly, in some instances, the ceramic shell is continuous, such as running along at least a portion of the nanofiber, such as at least 30% the length of the nanofiber, at least 50% the length of the nanofiber, at least 70% the length of the nanofiber, or the like.

A “1 C” charge or discharge rate is the rate at which a cell will be fully charged or discharged in one hour. Similarly, a 2 C charge or discharge rate is twice the rate of 1 C, and is the rate at which a cell will be fully charged or discharged in 0.5 hour. A 0.5 C charge or discharge rate is the rate at which a cell will be fully charged or discharged in 2 hours.

These and other objects, features, and characteristics of the system and/or process disclosed herein, as well as the processes of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. In addition, unless otherwise stated, values and characteristics described for individual components herein also include disclosure of such values and characteristics as an average of a plurality (i.e., more than one) of such components. Similarly, disclosure of average values and characteristics herein also includes a disclosure of an individual value and characteristic as applied to a single component herein.

In certain instances, a value “about” an indicated value is a value suitable for achieving a suitable result and/or a result similar as achieved using the identified value. In some instances, a value “about” an indicated value is between ½ and 2 times the indicated value. In certain instances, a value “about” an indicated value is ±50% the indicated value, ±25% the indicated value, ±20% the indicated value, ±10% the indicated value, ±5% the indicated value, ±3% the indicated value, or the like.

The term “carboxy” refers to a >C═O group.

The term “alkyl” as used herein, alone or in combination, refers to an (e.g., optionally substituted) straight-chain or (e.g., optionally substituted) branched-chain saturated or unsaturated hydrocarbon monoradical having, e.g., from one to about ten carbon atoms, more preferably one to six carbon atoms or one to three carbon atoms. Examples include, but are not limited to methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, n-butyl, isobutyl, sec-butyl, t-butyl, and longer alkyl groups, such as pentyl, and the like. Whenever it appears herein, a numerical range such as “C₁-C₆ alkyl,” means that in some embodiments, the alkyl group consists of 1 carbon atom; in some embodiments, 2 carbon atoms; in some embodiments, 3 carbon atoms; in some embodiments, 4 carbon atoms; in some embodiments, 5 carbon atoms; or, in some embodiments, 6 carbon atoms, although the present definition also covers the occurrence of the term “alkyl” where no numerical range is designated. In addition, in some instances, such as wherein the alkyl is substituted on either side, the alkyl may refer to a diradical derived from the above-defined monoradical, alkyl. Examples include, but are not limited to methylene (—CH₂—), ethylene (—CH₂CH₂—), propylene (—CH₂CH₂CH₂—), isopropylene (—CH(CH₃)CH₂—) and the like. An “alkyl” may also refer to a cyclic alkyl group, referring to an optionally substituted, saturated, hydrocarbon monoradical ring, containing, e.g., from three to about fifteen ring carbon atoms or from three to about six ring carbon atoms, though, in some embodiments, includes additional, non-ring carbon atoms as substituents (e.g. methylcyclopropyl). The term includes fused, non-fused, bridged and Spiro radicals. In some embodiments, a fused cycloalkyl contains from two to four fused rings where the ring of attachment is a cycloalkyl ring.

The term “aryl” as used herein, alone or in combination, refers to an (e.g., optionally, substituted) aromatic hydrocarbon radical of six to about twenty ring carbon atoms, and includes fused and non-fused aryl rings. A fused aryl ring radical contains from two to four fused rings where the ring of attachment is an aryl ring, and the other individual rings are alicyclic, heterocyclic, aromatic, heteroaromatic or any combination thereof. Further, the term aryl includes fused and non-fused rings containing from six to about twelve ring carbon atoms, as well as those containing from six to about ten ring carbon atoms. A non-limiting example of a single ring aryl group includes phenyl; a fused ring aryl group includes naphthyl, phenanthrenyl, anthracenyl, azulenyl; and a non-fused bi-aryl group includes biphenyl.

The term “heteroaryl” as used herein, alone or in combination, refers to (e.g., optionally substituted) aromatic monoradicals containing from about live to about twenty skeletal ring atoms, where one or more of the ring atoms is a heteroatom independently selected from among oxygen, nitrogen, and sulfur, but not limited to these atoms and with the proviso that the ring of said group does not contain two adjacent O or S atoms. In embodiments in which two or more heteroatoms are present in the ring, the two or more heteroatoms are the same as each another, or some or all of the two or more heteroatoms are different from the others. The term heteroaryl includes optionally substituted fused and non-fused heteroaryl radicals having at least one heteroatom. The term heteroaryl also includes fused and non-fused heteroaryls having from five to about twelve skeletal ring atoms, as well as those having from five to about ten skeletal ring atoms. In certain instances, bonding to a heteroaryl group is via a carbon atom or a heteroatom. A non-limiting example of a single ring heteroaryl group includes pyridyl or furanyl.

The term “heteroalkyl” as used herein, refers to (e.g., optionally substituted) alkyl structure, as described above, in which one or more of the skeletal chain carbon atoms (and any associated hydrogen atoms, as appropriate) are each independently replaced with a heteroatom (i.e. an atom other than carbon, such as though not limited to oxygen, nitrogen, sulfur, or combinations thereof). Exemplary heteroalkyl groups include straight chain groups, such as ethylene oxides (e.g., —CH₂CH₂On-), or ringed groups, such as tetrahydrofuran.

The term “halo” refers to a halogen group, such as fluoro, chloro, bromo, or the like.

A “substituted” group herein is substituted with any suitable group, such as with alkyl, heteroalkyl, aryl, heteroaryl, hydroxyl, halo, carboxy, COOR, OCOR, oxo (i.e., ═O) or the like, such as wherein R is H, alkyl, or heteroalkyl, such as wherein R is alkyl. An “unsubstituted’ group does not comprise any such substitutions (e.g., comprising only H groups beyond those explicitly described). Disclosure of an optionally substituted group herein includes explicit disclosure of both substituted and unsubstituted variants.

### BRIEF DESCRIPTION OF THE DRAWINGS

FIG. 1 illustrates a scanning electron microscopy (SEM) image of a surface comprising shelled nanofiber segments of an exemplary membrane provided herein.

FIG. 2 illustrates a scanning electron microscopy (SEM) image of a surface opposite a surface comprising shelled nanofiber segments of an exemplary membrane provided herein.

FIG. 3 illustrates an exemplary system provided herein comprising a bank of electrospray nozzles positioned opposite a substrate.

FIG. 4 illustrates a scanning electron microscopy (SEM) image of a surface comprising shelled nanofiber segments of an exemplary membrane provided herein.

FIG. 5 illustrates a scanning electron microscopy (SEM) image of a surface opposite a surface comprising shelled nanofiber segments of an exemplary membrane provided herein.

FIG. 6 illustrates the specific capacities exemplary cells described herein.

FIG. 7 illustrates the specific capacities exemplary cells described herein.

FIG. 8 illustrates exemplary electrospray nozzle apparatuses provided herein.

FIG. 9 illustrates the specific capacities exemplary cells described herein.

FIG. 10 illustrates the specific capacities exemplary cells described herein.

FIG. 11 illustrates the specific capacities exemplary cells described herein.

FIG. 12 illustrates the specific capacities exemplary cells described herein.

FIG. 13 illustrates an exemplary silsesquioxane cage structure.

FIG. 14 illustrates an exemplary silsesquioxane opened cage structure.

FIG. 15 illustrates exemplary monomeric units of a polysilazanes provided herein.

FIG. 16 illustrates an exemplary synthetic pathway and exemplary groups for manufacturing various polyimides.

FIG. 17 illustrates exemplary polyimides provided and/or utilized herein.

FIG. 18 illustrates excellent capacity and capacity retention characteristics of an exemplary separator system provided herein relative to exemplary polyolefin separator systems.

FIG. 19 illustrates rate capabilities of an exemplary separator system provided herein relative to exemplary polyolefin separator systems.

FIG. 20 illustrates wicking and wettability characteristics of an exemplary separator system provided herein relative to exemplary polyolefin separator systems.

### DETAILED DESCRIPTION OF THE INVENTION

Provided in certain embodiments herein are membranes, fiber mats, separators, and precursors thereof. Also provided herein are processes and systems for manufacturing the same. In some embodiments, processes and systems provided herein are suitable for and configured to manufacture uniform membranes and separators, such as having uniform thickness.

Provided in certain embodiments herein are membranes and separators, as well as precursors thereof. In general, such materials are thin membrane materials, such as having a thickness of less than 50 micron (e.g., 5-25 micron). In certain embodiments, the membranes and separators herein comprise a porous membrane material. In certain embodiments, the porous membrane generally has sub-micron sized pores, such as having an average or median (d50) pore size of less than 100 nm (e.g., about 30 nm to about 60 nm). In addition, in some embodiments, maximum pore sizes provided herein (e.g., d95, d98, d99, or the like) are generally sub-micron (e.g., less than 1 micron, or smaller). In various embodiments, a membrane or separator herein comprises a polymer-ceramic hybrid or composite material, such as a fiber (e.g., a membrane herein comprising a mat of fibers) or fiber segment comprising such as polymer-ceramic material. In various embodiments, the polymer-ceramic material comprises a polymer matrix material that is at least partially coated or encapsulated with a ceramic.

In some embodiments, membranes, separators and separator materials provided herein have good or improved mechanical performance characteristics (e.g., decreases failure rate during compression and/or overheating), rate capabilities (e.g., increases rate of charging), safety profiles (e.g., good thermal stability, reduced fail rate, etc.), wettability (e.g., which further reduces the amount of non-active material required in a battery), and other features, such as relative to commercial materials. In certain instances, separators and separator materials provided herein achieve such characteristics while also being thinner than typical commercial separators (e.g., <25 micron, or thinner).

Provided in various embodiments herein are separators and separator materials, having improved performance characteristics, as well as processes and materials for manufacturing the same. In some embodiments, separators and separator materials provided herein have good or improved mechanical performance characteristics (e.g., decreases failure rate during compression and/or overheating), rate capabilities (e.g., increases rate of charging), safety profiles (e.g., good thermal stability, reduced fail rate, etc.), wettability (e.g., which further reduces the amount of non-active material required in a battery), and other features, such as relative to commercial materials. In certain instances, separators and separator materials provided herein achieve such characteristics while also being thinner than typical commercial separators (e.g., <25 micron, or thinner).

In some embodiments, provided herein is a porous membrane. In specific embodiments, the porous membrane is or comprises a porous fiber mat (e.g., comprising a non-woven mat of one-dimensional materials that collectively form a porous material).

In certain embodiments, provided herein is a porous membrane comprising a polymer-ceramic hybrid material. In specific embodiments, the polymer ceramic hybrid material comprises a continuous matrix of a polymer and a continuous matrix of a ceramic. In certain embodiments, the hybrid material is a fiber mat (e.g., comprising a plurality of one dimensional fibers that collectively form a membrane).

In some embodiments, such as with a fiber mat or separator comprising a fiber mat is utilized, a high porosity is utilized, such as about 40% to about 70%. In certain embodiments, separators provided herein retain good capacity and rate capabilities while also retaining good mechanical and/or safety characteristics, despite the less continuous morphology of the material. In certain instances, thicker separators are utilized, however, to achieve such results. In some embodiments, fiber mat separators provided herein have a thickness of about 5 micron to about 25 micron, such as about 10 micron to about 20 micron, about 15 micron to about 25 micron, such as about 20 micron. In certain embodiments, thinner separators are preferred to allow more active material to be included in a battery, but performance characteristics, particularly safety parameters, should also be considered and/or met.

In certain embodiments, a membrane provided herein has a thickness variation of less than 20%. In preferred embodiments, the membrane provided herein has a thickness variation of less than 15%. In specific embodiments, the membrane provided herein has a thickness variation of less than 10%. In more specific embodiments, the membrane provided herein has a thickness variation of less than 5%. In various instances, low thickness variation materials are made possible by the processes provided herein. For example, in some instances, the use of gas-assisted electrospray techniques, such as provided herein, allow for the formation of fine aerosols that are uniformly distributed on a surface, such as to produce a material herein. In certain instances, such uniform deposition facilitates the formation of materials with very little thickness variation.

In certain instances, small pore sizes are desirable to avoid contact between negative and positive active electrode components. In general, such as in separators having a thickness of >20 micron, sub-micron pore sizes are sufficient to avoid contact between the negative and positive electrodes (which could cause short circuit, cell failure, fire, etc.). In certain instances, smaller pore sizes are desired for thinner separators, however, in order to reduce the chances of interaction between the two separators (e.g., due to use/distortion of the battery and separator, thermal distortion of the separator, smaller active electrode materials jutting into the pore—a small protrusion into the pore that may not be problematic with a thicker separator, could be problematic with a thinner separator, etc.).

In some embodiments, a membrane has a pore size distribution d95 of (i.e., wherein 95% of the pores, by number, have a size less than) about 1 micron or less. In specific embodiments, a membrane has a pore size distribution d98 of about 1 micron or less. In specific embodiments, a membrane has a pore size distribution d99 of about 1 micron or less. In more specific embodiments, a membrane has a pore size distribution d99.8 of about 1 micron or less. In still more specific embodiments, a membrane has a pore size distribution d99.9 of about 1 micron or less.

In certain embodiments herein, any membrane, separator, fiber or porous material comprising a polymer material or matrix and having a surface thereof has at least a portion of the surface coated with ceramic (e.g., a non-particulate based and/or two-dimensional and/or continuous ceramic coating). In specific embodiments, at least 20% of the surface is coated with ceramic. In more specific embodiments, at least 40% of the surface is coated with ceramic. In still more specific embodiments, at least 60% of the surface is coated with ceramic. In yet more specific embodiments, at least 80% of the surface is coated with ceramic. In more specific embodiments, at least 90% of the surface is coated with ceramic. In still more specific embodiments, at least 95%, at least 98%, or at least 99% of the surface is coated with ceramic.

In various instances, good surface coverage of the polymeric material with ceramic provides for a number of benefits to a hybrid/composite material. For example, in some instances, good ceramic coverage improved ionic mobility of the material (e.g., and in turn rate capability and/or capacity of a battery comprising the same), wettability (e.g., reducing the need for excess electrolyte, e.g., reducing the cost and volume of the overall cell), improving mechanical properties (e.g., tensile strength in the medial (md) and/or transverse (td) directions) (e.g., improving processability, reducing probability of damage caused during use, and/or improving safety parameters), improving thermal stability (e.g., reducing shrinkage at elevated temperatures, e.g., improving safety parameters), and/or other beneficial characteristics.

In various embodiments herein, any suitable amount of polymer and/or ceramic are utilized in the materials described herein. In specific embodiments, suitable amounts of polymer and ceramic are provided in the materials herein to achieve the morphologies described herein. In some embodiments, a material (e.g., separator, membrane, fiber mat, or the like) described herein comprises about 30 wt. % to about 99 wt. % polymer. In more specific embodiments, the material comprises about 40 wt. % to about 90 wt. % polymer. In some embodiments, a material (e.g., separator, membrane, fiber mat, or the like) described herein comprises about 1 wt. % to about 70 wt. % ceramic. In specific embodiments, the material comprises about 20 wt. % to about 50 wt. % ceramic. In some specific embodiments, a material provided herein comprises about 20 wt. % to about 50 wt. % (e.g., about 30 wt. % to about 50 wt. %) ceramic. In some specific embodiments, a material (e.g., mat or mat separator) provided herein comprises about 10 wt. % to about 30 wt. % ceramic (e.g., about 15 wt. % to about 30 wt. %).

In certain embodiments, a material (e.g., fiber) provided herein comprises a polymer matrix with a ceramic coating, such as described herein. In specific embodiments, the ceramic coating has any suitable thickness to impart a beneficial characteristic(s) to the material, such as one of the many described herein. In some embodiments, the material has a (e.g., average) thickness (e.g., diameter of a fiber), the polymer matrix (e.g., including any ceramic embedded therein) having a first thickness and the coating having a second thickness. In some instances, such as wherein a fiber is coated all the way around the fiber, a material has a polymer thickness, a first coating thickness and a second coating thickness. In some embodiments, the (e.g., average) thickness of a ceramic coating is about 30% or less of the (e.g., average) thickness of material (e.g., fiber). In specific embodiments, the (e.g., average) thickness of a ceramic coating is about 20% or less of the (e.g., average) thickness of material. In more specific embodiments, the (e.g., average) thickness of a ceramic coating is about 20% or less of the (e.g., average) thickness of material. In still more specific embodiments, the (e.g., average) thickness of a ceramic coating is about 15% or less of the (e.g., average) thickness of material. In yet more specific embodiments, the (e.g., average) thickness of a ceramic coating is about 8% to about 12% (e.g., about 10%) of the (e.g., average) thickness of material. In certain embodiments, the (e.g., average) thickness of the ceramic coating is at least 1% (e.g., at least 2%, at least 3%, at least 5%, or the like) of the overall (e.g., average) thickness of the material.

Any suitable polymer is utilized in the separators, membranes, fibers, mats, and the like described herein. In preferred embodiments, the polymer is a polymer compatible with one or more battery electrolyte, such as a lithium ion battery electrolyte. In certain embodiments, the polymer is polyvinyl alcohol (PVA), polyacrylonitrile (PAN), polyvinylidene difluoride (PVDF), polyvinylpyrrolidone (PVP), polyimide (PI), or a combination thereof. In specific embodiments, the polymer is PAN or PVDF.

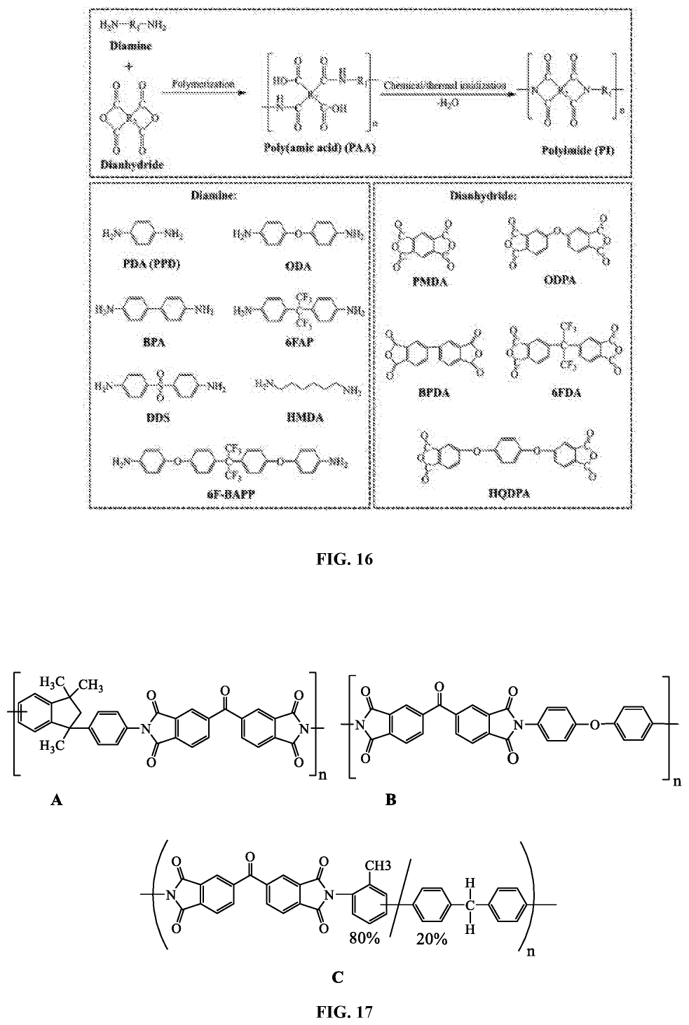

In specific embodiments, a polyimide, such as described herein is preferred. FIG. 16 illustrates a synthetic scheme suitable for producing various polyimides, including polyimides utilized in processes and compositions of matter (e.g., nanofibers, nanofiber mats, and separators) provided herein. As illustrated, in some instances, a polyimide is manufactured by combining a diamine and/or dicyanate (—N═C═O) with a dianhydride. Any suitable dianhydride and diamine and/or dicyanate is utilized in such instances. In certain instances, mixtures of diamine and/or dicyanate and/or mixtures of dianhydride are utilized to prepare polyimides that comprise co-polyimide structures.

In certain embodiments, provided herein are polyimides prepared using any one or more diamine of FIG. 16. In certain embodiments, provided herein are polyimides prepared using any one or more dianhydride of FIG. 16. For example, in some instances ODA is combined with PMDA to form Kapton, having the structure B of FIG. 17. In certain embodiments, a polyimide provided herein is a co-polyimide, such as P84, illustrated by structure C in FIG. 17 (e.g., which can be prepared by reacting toluene diisocyanate (TDI), methylene diphenyl diiosocyanate (MDI), and 3,3′,4,4′-Benzophenonetetracarboxylic dianhydride (BTDA) (e.g., as a random or block co-polymer). In certain embodiments, polyimide provided herein is Matrimid, illustrated by structure A in FIG. 17, such as prepared using the following diamine:

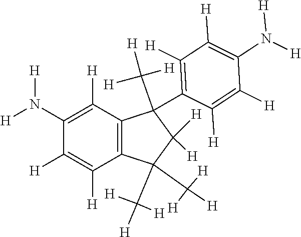 [SMILES: CC1(C)CC(C)(c2ccc(N)cc2)c2cc(N)ccc21]

In certain specific embodiments, the polymer is a polyimide (PI) comprising a radical or repeating unit (e.g., along with other repeat unit(s)) of formula (Ia) in the backbone thereof:

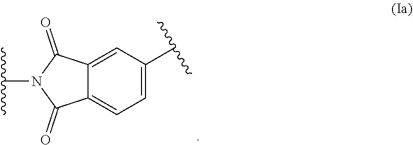

In some embodiments, the polymer is a polyimide (PI) comprising a radical or repeating unit (e.g., along with other repeat unit(s)) of formula (Ib) in the backbone thereof:

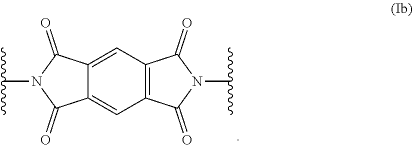

In certain embodiments, the polymer is a polyimide (PI) comprising a radical or repeating unit (e.g., along with other repeat unit(s)) of formula (II) in the backbone thereof:

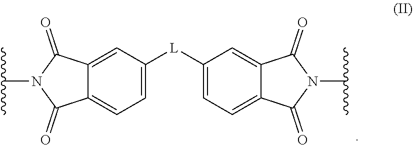

In some embodiments, each L is any suitable linker unit. In specific embodiments, each L independently absent, carboxy, or alkyl. In more specific embodiments, each L independently absent or carboxy.

In certain embodiments, the polymer is a polyimide (PI) comprising a radical or repeating unit (e.g., along with other repeat unit(s)) of formula (III) in the backbone thereof:

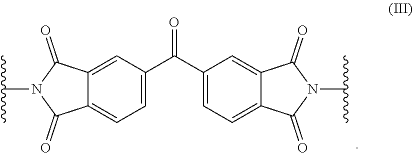

In some embodiments, the polymer is a polyimide (PI) comprising a radical or repeating unit (e.g., along with other repeat unit(s)) of formula (IVa):

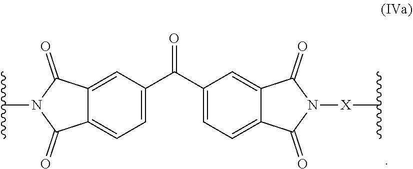

In some embodiments, the polymer is a polyimide (PI) comprising a radical or repeating unit (e.g., along with other repeat unit(s)) of formula (IVb):

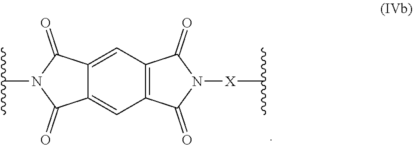

In certain embodiments, each X unit is any suitable linking unit. In specific embodiments, each X is independently a hydrocarbon (e.g., substituted or non-substituted, such as with alkyl, heteroalkyl, aryl, heteroaryl, hydroxyl, halo, carboxy, COOR, OCOR, or the like, such as wherein R is H, alkyl, or heteroalkyl, such as wherein R is alkyl). In more specific embodiments, the hydrocarbon comprises one or more aryl and one or more alkyl group. In still more specific embodiments, the hydrocarbon is (substituted or non-substituted) alkyl, aryl (e.g., as exemplified in Va and Vb), aryl-alkyl, alkyl-aryl, or aryl-alkyl-aryl (e.g., as exemplified in Via and VIb, wherein L² is alkyl).

In specific embodiments, the polymer is a polyimide (PI) comprising a radical or repeating unit (e.g., along with other repeat unit(s)) of formula (Va). In specific instances, the radical of formula (Va) is the repeating unit of the polymer, comprising n repeat units, wherein n is an integer.

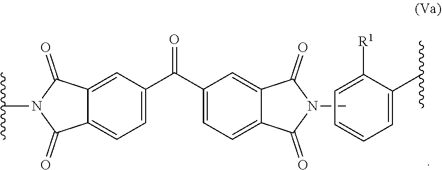

In other specific embodiments, the polymer is a polyimide (PI) comprising a radical of formula (Vb). In specific instances, the radical of formula (Vb) is the repeating unit of the polymer, comprising n repeat units, wherein n is an integer.

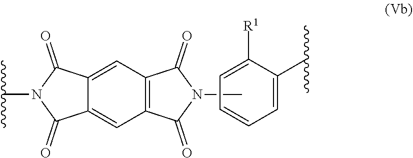

In certain embodiments, the phenyl of the residue of Va is substituted with any R1 at four locations (those locations not attached to the polymer backbone). In specific instances, each R¹ is independently H, alkyl, heteroalkyl, halo, OH, COOR, OCOR, or the like (wherein R is as defined herein). In more specific embodiments, each R¹ is independently H or alkyl.

In other specific embodiments, the polymer is a polyimide (PI) comprising a radical of formula (VIa). In specific instances, the radical of formula (VIa) is the repeating unit of the polymer, comprising n repeat units, wherein n is an integer.

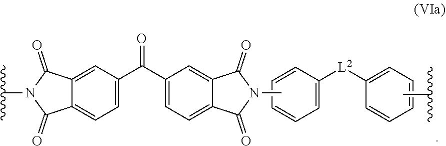

In other specific embodiments, the polymer is a polyimide (PI) comprising a radical of formula (VIb). In specific instances, the radical of formula (VIb) is the repeating unit of the polymer, comprising n repeat units, wherein n is an integer.

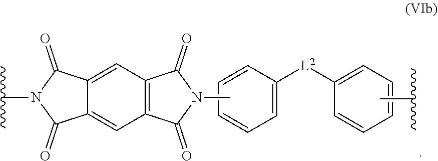

In some embodiments, each L2 is any suitable linker unit. In certain embodiments, each L2 independently absent, —O—, carboxy (>C═O), or alkyl. In specific embodiments, each L2 independently absent, carboxy, or alkyl. In more specific embodiments, each L2 independently absent or alkyl. In certain instances, each L2 is independently substituted or non-substituted, such as with alkyl, heteroalkyl, aryl, heteroaryl, hydroxyl, halo, carboxy, COOR, OCOR, or the like, such as wherein R is H, alkyl, or heteroalkyl, such as wherein R is alkyl.

In some instances, a polymide or polymer provided herein is a co-polyimide, such as a polyimide comprising radicals or repeat units of (i) at least one of formula (Va) and/or formula (Vb), and (ii) at least one of formula (VIa) and/or formula (VIb).

In certain embodiments, any polymer n value is any suitable integer, such as an integer suitable to provide a suitable polymer molecular weight, such as described herein. In some embodiments, n is 1 to 20,000, such as 100 to 10,000, or the like.

Any suitable ceramic is utilized in the separators, membranes, fibers, mats, and the like described herein. In certain embodiments, the ceramic is a precursor derived ceramic, such as a ceramic derived from a ceramic precursor that is liquid or soluble in or (e.g., at least partially) miscible with water, aqueous solutions, alcohol, dimethylformamide (DMF), combinations thereof, or the like. In certain embodiments, the ceramic is a silicon based ceramic, such as a silicon-oxycarbonnitride (SiCNO) ceramic, a silicon-oxycarbide (SiCO) ceramic, a silicon-carbonnitride (SiCN) ceramic, a silicon-oxynitride (SiNO) ceramic, a silicon oxide (SiOx) ceramic, a silicon nitride (SiNx) ceramic, a silicon carbide (SiCx) ceramic, combinations thereof, or the like. In certain embodiments, the ceramic is a polymer derived ceramic (PDC), such as a ceramic derived from a polysilazane, a poly(organosilazane), a poly(organosilylcarbodiimide), a poly(organosiloxane), any combination thereof, or the like. In some embodiments, the ceramic is a sol-gel derived ceramic, such as a ceramic derived from silicic acid (e.g., orthosilicic acid, disilicic acid, metasilicic acid, pyrosilicic acid, or combinations thereof), or an alkylated derivative thereof, such as tetraethyl orthosilicate (TEOS), tetramethyl orthosilicate (TMOS), or the like. In various embodiments, other ceramics are derived from precursors such as silicon salts, such as silicon acetate, silicon chloride, or the like. In certain embodiments, a ceramic precursor is a precursor of a silicon based ceramic (e.g., SiCNO, SiCO, SiCN, SiNO, SiO ceramics). In specific embodiments, the ceramic precursor is a polymer derived ceramic (PDC) precursor (e.g., polysilazane, poly(organosilazanes), poly(organosilylcarbodiimides), polysiloxanes, and poly(organosiloxanes)). In specific embodiments, the ceramic precursor is a polysilazane (e.g., a poly(organosilazane)). In some embodiments, the ceramic precursor is a siloxane (e.g., a poly(organosiloxane), methylsiloxane (MSX)). In certain embodiments, the ceramic precursor is a silsesquioxane (e.g., methyl silsesquioxane (MSQ), a polysilesquioxane (PSSQ), or a polyhedral oligomeric silsesquioxane (POSS)). In some embodiments, the ceramic is a sol-gel precursor (e.g., a silicate, such as silicic acid, TMOS, TEOS). In some embodiments, any combination of such ceramic precursors are also contemplated herein.

As discussed herein, separators or membranes provided herein have very good performance characteristics, such as relative to typical commercial separators. For example, in certain embodiments, materials (e.g., separators, membranes) provided herein have good wettability characteristics (e.g., which can reduce electrolyte cost, reduce the chance of electrolyte leakage, and/or reduce volume and/or weight of a cell, etc.). In certain embodiments, a material provided herein has an electrolyte uptake capacity of at least 3 times the mass of the material. In specific embodiments, a material provided herein has an electrolyte uptake capacity of at least 5 times the mass of the material. In more specific embodiments, a material provided herein has an electrolyte uptake capacity of at least 6 times the mass of the material. In still more specific embodiments, a material provided herein has an electrolyte uptake capacity of at least 7 times the mass of the material. In yet more specific embodiments, a material provided herein has an electrolyte uptake capacity of at least 8 times the mass of the material. On the other hand, some more conventional commercial separators have an electrolyte uptake capacity of less than 3 times the mass of the separator.

In certain embodiments, materials (e.g., separators, membranes) provided herein have good thermal stability. In some embodiments, materials have a shrinkage (e.g., in either or both the machine direction (md) and/or transverse direction) of less than 3% at 90° C. (e.g., after 1 hour). In specific embodiments, materials herein have a shrinkage of less than 2% at 90° C. (e.g., after 1 hour). In more specific embodiments, materials herein have a shrinkage of less than 1% at 90° C. (e.g., after 1 hour). In still more specific embodiments, materials herein have a shrinkage of less than 0.5% at 90° C. (e.g., after 1 hour). In yet more specific embodiments, materials herein have a shrinkage of less than 0.2% at 90° C. (e.g., after 1 hour). By contrast, typical commercial separator materials have shrinkages (in the machine direction) of about 5% or greater at 90° C. For example, CELGARD® 2325 (25 micron microporous trilayer membrane (PP/PE/PP)) has an MD shrinkage at 90° C. of 5% after 1 hour, CELGARD® 2340 (38 micron microporous trilayer membrane (PP/PE/PP)) has an MD shrinkage at 90° C. of 7% after 1 hour, and CELGARD® 2400 (25 micron microporous monolayer membrane (PP)) has an MD shrinkage at 90° C. of 5% after 1 hour. In some embodiments, materials have a shrinkage (e.g., in either or both the machine direction (md) and/or transverse direction) of less than 20% at a temperature of at least 200° C. (e.g., after 1 hour). In specific embodiments, materials herein have a shrinkage of less than 15% at a temperature of at least 200° C. (e.g., after 1 hour). In more specific embodiments, materials herein have a shrinkage of less than 10% at a temperature of at least 200° C. (e.g., after 1 hour). In still more specific embodiments, materials herein have a shrinkage of less than 5% at a temperature of at least 200° C. (e.g., after 1 hour). In yet more specific embodiments, materials herein have a shrinkage of less than 3% at a temperature of at least 200° C. (e.g., after 1 hour). In more specific embodiments, materials herein have a shrinkage of less than 2% at a temperature of at least 200° C. (e.g., after 1 hour).

In certain embodiments, a material (e.g., separator, membrane) provided herein has a strain of less than ±20% (i.e., between −20% and +20% (shrinkage and expansion)) at a temperature of at least 200° C. and a controlled force of 0.001 N (e.g., in longitudinal (md) and/or transverse directions (td)). In specific embodiments, the material has a strain of less than ±10% at a temperature of at least 200° C. and a controlled force of 0.001 N (e.g., in longitudinal (md) and/or transverse directions (td)). In more specific embodiments, the material has a strain of less than ±5% at a temperature of at least 200° C. and a controlled force of 0.001 N (e.g., in longitudinal (md) and/or transverse directions (td)). In still more specific embodiments, the material has a strain of less than ±3% at a temperature of at least 200° C. and a controlled force of 0.001 N (e.g., in longitudinal (md) and/or transverse directions (td)). In yet more specific embodiments, the material has a strain of less than ±2% at a temperature of at least 200° C. and a controlled force of 0.001 N (e.g., in longitudinal (md) and/or transverse directions (td)).

In certain embodiments, the materials (e.g., separator, membrane) provided herein have good air permeability (e.g., demonstrating good fluid flow characteristics thereof). In some embodiments, the materials have an air flow rate (e.g., therethrough) of at least 10 mL/s at a differential pressure of 35 pounds per square inch (psi). In specific embodiments, the materials have an air flow rate (e.g., therethrough) of at least 20 mL/s at a differential pressure of 35 psi. In more specific embodiments, the materials have an air flow rate (e.g., therethrough) of at least 30 mL/s at a differential pressure of 35 psi. In still more specific embodiments, the materials have an air flow rate (e.g., therethrough) of at least 40 mL/s at a differential pressure of 35 psi.

Also provided in certain embodiments herein are energy storage devices comprising a material (e.g., separator, membrane) described herein. In certain embodiments, an energy storage device (e.g., battery, such as a lithium battery, e.g., lithium ion battery) comprises a first electrode (e.g. positive electrode), a second electrode (e.g., a negative electrode), and a separator described herein. In specific embodiments, the separator is positioned between (e.g., as a physical barrier) between the first and second electrode. In specific embodiments, the energy storage device further comprises an electrolyte (e.g., the separator being wetted with the electrolyte).

In certain embodiments, energy storage devices proved herein have very good rate capabilities (e.g., that retain good and reversible energy storage capacities, even at fast charge rates).

Provided in certain embodiments herein are process for manufacturing materials (e.g., separators, membranes, fibers, mats, or the like) described herein. In some embodiments, the process comprises gas-assisted ejection of a fluid stock from a conduit. In specific embodiments, the conduit is a part of a gas-assisted nozzle, the conduit comprising an inlet and an outlet and the gas assisted nozzle configured to provide a high velocity gas at or near the outlet of the conduit. In certain embodiments, the nozzle is configured to receive a voltage, such as to facilitate electrospinning and/or electrospraying of a fluid stock therethrough.

In some embodiments, provided herein is a process for manufacturing a material herein, the process comprising injecting a fluid stock into a (e.g., high velocity) gas stream. In some embodiments, the fluid stock comprises a ceramic precursor and a liquid medium. In certain embodiments, the process comprises providing an electrostatic charge to the fluid stock prior to injecting the fluid stock into the gas stream.

Any suitable nozzle configuration is also contemplated herein. For example, in some embodiments, the conduit gap (e.g., the average distance between the inner and outer wall of the second conduit, such as on a line drawn from the center of the first conduit and extending outward through the second conduit that at least partially surrounds the first conduit) is about 0.05 mm to about 30 mm. In specific embodiments, the conduit gap is about 0.05 mm to about 20 mm. In more specific embodiments, the conduit gap is about 0.1 mm to about 10 mm. In certain embodiments, a gas stream is provided or ejected from the nozzle in a similar direction or along a common axis with the direction/axis upon which the fluid stock is ejected from the nozzle (e.g., within 15 degrees, within 10 degrees, within 5 degrees, within 3 degrees, or the like). In specific embodiments, the inner surface of the outer walls defining the first and second conduit are within 15 degrees of parallel of one another for at least a portion of the length of the first and second conduits ((e.g., the length of the portion of the nozzle wherein the first and second conduits are within 15 degrees (e.g., within 10 degrees, within 5 degrees, or the like) of parallel of one another being the conduit overlap length). In particular, such common directionality is provided in the segment of the conduits proximal to the first and/or second outlet and/or the nozzle terminus. In certain embodiments, the ratio of the conduit overlap length (e.g., the overlap length being the length of the overlap segment having common directionality and located proximal to the first and/or second outlet) to the first diameter is about 1 or more (e.g., about 2 or more, about 3 or more, about 5 or more, about 1 to about 10). In more general instances, upon ejection of the fluid stock from the nozzle or injection of the fluid stock into the gas stream, a jet is formed from the fluid stock, the high velocity gas or the gas stream at least partially surrounding the jet.

In certain embodiments, provided herein is a process for manufacturing a membrane or separator herein, the process comprising generating a jet, plume or aerosol from a fluid stock. Generally, the fluid stock comprises a liquid and a ceramic precursor, and optional further inclusion materials. In specific embodiments, the jet, plume or aerosol is generated using a suitable technique, such as a spinning (e.g., electrospinning) or spray (e.g., electrospray) technique. In some embodiments, the process further comprises generating the jet, plume or aerosol in the presence of a high velocity gas. In specific instances, the high velocity gas facilitates the fine dispersion of the plume or aerosol particulates, which, in turn, facilitates the controlled and uniform deposition of the liquid and/or inclusion parts on a membrane surface. In some instances, the direction of the flow of the gas and the jet/plume/aerosol are in the same general direction (e.g., having a directional mean within 15 degrees, 10 degrees, 5 degrees, or the like of each other).

In some embodiments, provided herein are membranes, separators, and precursors thereof, as well as systems and processes for manufacturing the same. In some embodiments, membranes, separators and precursors thereof have a thickness of about 1 micron to about 50 micron (e.g., about 5 micron to about 25 micron). In some embodiments, thicker or thinner materials are also contemplated, as desired. In certain embodiments, the system is configured to or the process comprises injecting a fluid stock into a gas stream. In specific embodiments, the fluid stock is injected into the gas stream in a substantially parallel direction (e.g., within about 10 degrees, about 5 degrees, about 2 degrees, or the like of parallel). In specific embodiments, the process comprising producing an electrostatically charged jet or plume. In more specific embodiments, the plume comprises a plurality of nanoscale particles and/or droplets (e.g., <10 micron in average dimension or diameter).

In some embodiments, the plume is generated by: providing a fluid stock to a first inlet of a first conduit of an electrospray nozzle. In specific embodiments, the first conduit being enclosed along the length of the conduit by a wall having an interior surface and an exterior surface, the first conduit having a first outlet. In some embodiments, the fluid stock comprises a ceramic precursor. In certain embodiments, the process comprises providing a (e.g., direct current) voltage to the nozzle (e.g., wall of the first conduit). In some instances, the voltage provides an electric field (e.g., at the first outlet) (e.g., which field at least partially drives the electrospraying process). In further or additional embodiments, the process further comprises providing a pressurized gas (e.g., provided from a gas supply, such as a pump, a pressurized reservoir, or the like) (e.g., a system being configured to provide a pressurized gas) to a second inlet of a second conduit of the nozzle, e.g., thereby providing high velocity gas at a second outlet of the second conduit (e.g., the high velocity gas having a velocity of about 0.1 m/s or more, about 0.5 m/s or more, about 1 m/s or more, about 5 m/s or more, about 50 m/s or more, or the like). In some embodiments, the second conduit is enclosed along the length of the conduit by a second wall having an interior surface, the second conduit having a second inlet and a second outlet. In specific embodiments, the smallest gap between a wall defining first conduit and a wall defining the second conduit is a conduit gap (e.g., the ratio of the conduit overlap length to the first diameter being about 1 to 10). In specific embodiments, the droplets (e.g., partially or wholly dried in the plume) are collected on a substrate (e.g., as a dry or semi-wet deposition on the membrane or nanofiber mat). In some embodiments, the membrane or nanofiber mat is configured between a grounded collector and the nozzle.

In some instances, ejecting of a fluid stock (e.g., charged fluid stock) from a nozzle (e.g., electrospray nozzle) produces a fluid jet, which may be disrupted to form a plume comprising a plurality of droplets (or plume particulates) (e.g., if the polymer concentration is low enough). In certain instances, the jet or droplets are in varying states of dryness (e.g., wherein more dry materials comprise less fluid medium relative to solid inclusion materials) as they move toward a collector, with the materials (jet/droplets) near the collector being dryer (i.e., comprising less fluid medium) (or even completely dry) than those materials (jet/droplets) near the nozzle. In some instances, the plume comprises (e.g., especially in closest proximity to the collector substrate) droplets wherein all fluid medium has been evaporated. In preferred embodiments, plume droplets (particularly in proximity to the collector substrate surface) are disrupted and small enough to reduce or minimize the number and/or amount of inclusion component (e.g., polymer, ceramic precursor, liquid medium, and/or the like) included within each droplet. In certain instances, reducing and/or minimizing the number and/or amount of inclusion in each droplets facilitates good distribution of inclusion throughout the plume, particularly in proximity to the collector. In some instances, good distribution of inclusions within the plume facilitates good distribution of inclusions as collected on the collector substrate. In particular, membranes and coatings suffer from poor performance characteristics due to lack of uniformity of the membrane (e.g., due to variations in dispersion and/or concentration of inclusions, variations in membrane thickness, etc.).

In some instances, typical spray techniques are insufficient to adequately disrupt and break apart the droplets of the plume and are insufficient to provide good distribution of the inclusion materials in the plume and on the collector substrate so as to provide dispersions with good uniformity, particularly in systems comprising multiple inclusion types. Instead, typical spray techniques have been observed to produce agglomerations, including co-agglomerations with poor dispersion uniformity and control, without which resultant materials exhibit poor or insufficient performance characteristics.

In certain instances, processes herein comprise generating a jet, plume or aerosol (e.g., electrospraying a fluid stock) with a high velocity gas (e.g., ≥0.1 m/s, ≥0.5 m/s, ≥1 m/s, ≥5 m/s, ≥10 m/s, ≥20 m/s, ≥25 m/s, ≥50 m/s). In some instances, an (e.g., electrostatically charged) fluid stock is injected into a stream of high velocity gas. In certain instances, the high velocity gas facilitates further disruption (e.g., breaking apart) of the droplets formed during spray (e.g., electrospray) of the fluid stock. In some instances, the good dispersion of the droplets and the low concentration of inclusions per droplets facilitates the formation of a well-dispersed and well-controlled systems, such as described herein.

In certain embodiments, processes and systems described herein are suitable for high throughput of highly viscous fluid stocks. In certain instances, such processes facilitate the spray of fluid stocks having a much higher inclusion content than would typically be possible. In addition, in some embodiments, high concentrations of inclusion components are preferred in order to facilitate good coverage of a surface (of a collector or substrate), good uniformity of coatings (e.g., thickness, dispersion, etc.), and/or the like. In certain embodiments, the fluid stock provided herein comprises at least 0.1 wt. %, at least 0.5 wt. %, or at least 1 wt. % inclusion component (e.g., precursor), e.g., at least 2 wt. % inclusion component, at least 2.5 wt. % inclusion component, at least 3 wt. % inclusion component, at least 5 wt. % inclusion component, or the like (e.g., up to 50 wt. %, up to 30 wt. %, up to 20 wt. %, up to 15 wt. %, up to 10 wt. %, or the like). In certain embodiments, the fluid stock comprises about 2 wt. % to about 15 wt. % (e.g., about 10 wt. % to about 15 wt. %) inclusion component.

Any suitable substrate is optionally utilized. In some instances, the substrate (e.g., membrane or nanofiber) or positioned between a plume generating nozzle and a grounded surface. In certain embodiments, the substrate has a surface that is positioned in opposing relation to a plume generating nozzle outlet (e.g., there is “line of sight” between the nozzle outlet and the substrate surface). In specific embodiments, the opposing substrate is directly opposing the nozzle. In other specific embodiments, the opposing substrate is angled or offset from directly opposing the nozzle. In some embodiments, the substrate is affixed to or is a part of a conveyor system (e.g., to facilitate continuous manufacturing of coatings, membranes, or the like). In specific embodiments, the substrate is attached to a conveyor belt or is a part of a conveyor belt.

In certain embodiments, a process described herein is a gas assisted or gas controlled process. In some embodiments, a fluid stock provided herein is sprayed or spun with a gas stream. In specific embodiments, a fluid stock described herein is injected into a gas stream during electrospraying or electrospinning. In some embodiments, a process of producing of an electrostatically charged jet or plume from a fluid stock further comprises providing a pressurized gas to a second inlet of a second conduit of a nozzle described herein. In specific embodiments, the second conduit has a second inlet and a second outlet, and at least a portion of the first conduit being positioned inside the second conduit (i.e., at least a portion of the second conduit being positioned in surrounding relation to the first conduit). In certain embodiments, the gap between the inner conduit and the outer conduit is small enough to facilitate a high velocity gas at the nozzle, such as to facilitate sufficient disruption of the charged fluid (jet) ejected from the nozzle (e.g., such as to provide plume or aerosol dispersions described herein). In some embodiments, the conduit gap is about 0.01 mm to about 30 mm, such as about 0.05 mm to about 20 mm, about 0.1 mm to about 10 mm, or the like. In certain embodiments, the gas stream (e.g., at the second outlet) has a high velocity, such as a velocity of at least 0.5 m/s, e.g., at least 1 m/s, at least 5 m/s, at least 10 m/s, at least 20 m/s, or more.

In further or alternative embodiments, membranes provided herein have uniform thickness (e.g., the systems and/or processes provided herein provide even distribution of droplets over the target surface area, and/or deliver small droplets to the surface, minimizing “high spots” caused by large droplets/particle depositions). In specific embodiments, the membrane has a thickness variation (e.g., in a selected area, such as when an entire surface is not coated, such as an area that is not near the edge of the coating, e.g., an area that is more than 10% or 20% of the length, width, or diameter away from the edge of the coating) of less than about 100% of the average membrane thickness, e.g., about 50% or less of the average membrane thickness, about 20% or less of the average thickness, about 10% or less of the average thickness, about 5% or less of the average thickness, or the like. In some embodiments, the standard deviation of the membrane thickness is less than 200% the average thickness, less than 100% the average thickness, less than 50% the average thickness, less than 20% the average thickness, or the like.

In certain embodiments, a ceramic precursor included in a process or fluid stock provided herein is polysilazane, silsesquioxane (e.g., polyhedral oligomeric silsesquioxane (POSS), or polysilsesquioxane (PSSQ)), and/or combinations thereof.

In specific embodiments, the fluid stock comprises a polymer (e.g., in a concentration low enough such that a fiber is not formed upon manufacturing using a process and/or system described herein). In specific embodiments, the concentration of the polymer in the fluid stock is about 5 wt. % or less (e.g., about 0.5 wt. % to about 5 wt. %). In some instances, higher concentrations are utilized for spin techniques described herein, such as about 5 wt. % to about 20 wt. %.

In some embodiments, the fluid stock comprises a liquid medium, e.g., the liquid medium serving to dissolve and/or suspend the additives. Any suitable liquid medium is optionally used, but in specific embodiments, the liquid medium is or comprises, by way of non-limiting example, water, an alcohol, dimethylformamide (DMF), tetrahydrofuran (THF), Dimethylacetamide (DMAc), dichloromethane (DCM), chloroform, or N-methyl-pyrrolidone (NMP). In some embodiments, the liquid medium is utilized to dissolve and/or suspend additives described herein. In some instances, e.g., to facilitate uniformity of the fluid stock (e.g., solutes and/or suspended agents therein), the fluid stock is agitated (e.g., by stirring, sonicating, and/or any other suitable mechanism) prior to being provided to the first inlet. In certain embodiments, if a liquid polymer (e.g., melt) or liquid precursor is utilized, the amount of liquid medium utilized may be reduced or eliminated.

In certain embodiments, the spraying process and/or system provided herein comprises applying and/or is configured to provide a voltage to the nozzle, the voltage being about 8 kV to about 30 kV (e.g., about 10 kV to about 25 kV). In certain embodiments, such as wherein multiple nozzles are utilized, higher voltages are contemplated. In certain embodiments, a power supply is configured to provide a voltage to the nozzle. In some instances, higher voltage are optionally utilized when a voltage is applied to nozzle system comprising a number of nozzles. In some embodiments, if appropriate, a voltage is optionally not applied to a system and/or process provided herein.

In certain embodiments, processes and/or systems provided herein allow high flow rates (e.g., relative to other spray systems). In specific embodiments, the flow rate of the fluid stock (e.g., provided to the first inlet of the nozzle) is about 0.05 or more (e.g., about 0.05 mL to about 5 mL/min, about 0.1 mL or more, about 0.5 mL or more, about 1 mL or more, or the like).

In certain embodiments, processes and/or systems provided herein allow the processing of highly viscous fluids (e.g., relative to other spray systems). In some embodiments, the fluid stock has any suitable viscosity. In addition, the process and systems described herein allow for the manufacture of membranes and separators using highly viscous (and, e.g., highly loaded) fluid stocks, if desired. For example, in some embodiments, fluid stocks utilized in systems and processes herein have a viscosity of about 0.5 centipoise (cP) or more, e.g., about 5 cP or more, or about 1 cP to about 10 Poise. In more specific embodiments, the viscosity is about 10 cP to about 10 Poise. In some instances, gas-driven systems and processes described herein allow for the production of a jet, aerosol or plume that has enough inclusion component to facilitate good, high through-put formation of membranes (e.g., mats) that would not be possible using conventional techniques. In certain embodiments, the viscosity of the fluid stock is at least 200 centipoise (cP), such as at least 500 cP, at least 1000 cP, at least 2000 cP, at least 2,500 cP, at least 3,000 cP, at least 4,000 cP, or the like (e.g., up to 20,000 cP, up to about 10,000 cP, or the like). In certain embodiments, the viscosity of the fluid stock is about 2,000 cP to about 10,000 cP.

In some embodiments, provided herein is a process for producing a (e.g., porous) membrane or separator, the process comprising spraying (e.g., electrospraying) a fluid stock with a gas (e.g., a controlled gas flow). In certain embodiments, the fluid and the gas are ejected from a spray (e.g., electrospray) nozzle in a similar direction. In some instances, the direction of ejection of the fluid stock and the gas from the nozzle is within about 30 degrees of one another, or, more preferably within about 15 degrees of one another (e.g., within about 10 degrees or within about 5 degrees of one another). In certain embodiments, the fluid stock and the gas are configured to be ejected from the nozzle in a coaxial configuration. In some instances, configurations and processes described herein allow for an enhanced driving force (e.g., of electrospray), combining the driving forces of electric field gradient with high speed gas. In certain instances, configurations and processes described herein provided for several improvements in electrospray/electrospin processing, including in the manufacture of membranes and separators, such as described herein. In addition, in some instances, such configurations allow for process throughput up to tens or hundreds of times greater than simple electrospray and/or electrospin manufacturing and allow for the processing of high viscosity and/or highly loaded fluids. Moreover, in some instances, such techniques and systems allow for the manufacture of highly uniform membranes, separators, and the like. By contrast, other or conventional electrospray is not generally of commercial use in such applications because of, e.g., non-uniform deposition of large drops and dispersion of inclusions in droplets, especially for complex systems.

In some instances, spraying (e.g., using a process and/or system provided herein) of the fluid stock results in the formation of a jet, e.g., which subsequently deforms into a plume comprising a plurality of droplets (collectively referred to herein so as to encompass, e.g., droplet solutions, droplet suspensions, and/or solid particles in an plume or aerosol). In certain instances, spray (e.g., electrospray) (e.g., using a process and/or system provided herein) of a fluid stock, such as provided herein results in the formation of a plume comprising a plurality of droplets (collectively referred to herein so as to encompass, e.g., droplet solutions, droplet suspensions, and/or solid particles in an electrospray plume). In some instances, the processes described herein results in the formation of small droplets (e.g., micro- or nano-scale droplets) having highly uniform size distributions.

In certain instances, uniformity in the plume/aerosol allows for much greater control of deposition formation, such as thickness, thickness uniformity, compositional uniformity, and the like. In certain embodiments, membranes or separators provided herein have an average thickness (d_{f}) that is about 50 micron or less, such as about 35 micron or less, about 25 micron or less, or about 15 micron or less. In some embodiments, the thickness of the membrane is controlled by limiting or lengthening the residence time of a collector surface opposite an active nozzle system (e.g., using batch or continuous (e.g., using a conveyor) system). In certain embodiments, the membranes or separators provided herein have good thickness uniformity, such as wherein the thinnest portion of the membrane is >d_{f}/10, >d_{f}/5, >d_{f}/4, >d_{f}/3, >d_{f}/2, or the like. In further or alternative embodiments, the thickest portion of the membranes or separators is <10×d_{f}, <5×d_{f}, <3×d_{f}, <2×d_{f}, <1.5×d_{f}, <1.2×d_{f}, or the like.

In certain embodiments, the plurality of particles and/or droplets of an aerosol or plume provided herein are micron or sub-micron (e.g., nano or meso) scaled particles and/or droplets. In more specific embodiments, the plurality of particles and/or droplets have an average diameter of about 100 microns or less, about 50 microns or less, less than 30 micron, about 20 microns or less, less than 15 micron, or about 10 microns or less. In still more specific embodiments, the plurality of particles and/or droplets have an average diameter of about 5 microns or less, e.g., about 1 micron or less. In certain embodiments, the size of the particles and/or droplets is highly uniform (e.g., at a given distance from the nozzle), with the standard deviation of the particle and/or droplet size (e.g., at a given distance from the nozzle) being about 50% of the average size of the particles and/or droplets, or less (e.g., about 40% or less, about 30% or less, about 20% or less, about 10% or less, or the like) (e.g., at any given distance from the nozzle, e.g., about 10 cm or more, about 15 cm or more, about 20 cm or more, about 25 cm or more, from the nozzle, or about halfway between the nozzle and the collector, ¾ of the way from the nozzle to the collector, or the like).

In some embodiments, the fluid stock, the jet, and/or the plume comprises a fluid (e.g., water) and an inclusion component (e.g., polymer and/or ceramic precursors). In certain embodiments, compositions provided herein comprise a plurality of droplets, a jet, or a fluid stock comprising a fluid (e.g., water), a polymer, and a ceramic precursor. In various embodiments, individual droplets optionally comprise one or more inclusion type and/or other additive. Further, some or all of the fluid of the droplets (of the plume) may be evaporated during processing (e.g., prior to deposition). In various embodiments, concentrations of inclusion materials in droplets described herein, or a composition comprising the same, are generally higher than the concentrations of such materials in the fluid stock, or even in the jet (where evaporation of the fluid begins). In certain embodiments, droplets or compositions comprising the droplets having inclusions concentrations of at least 1.5×, at least 2×, at least 3×, at least 5×, at least 10×, or the like (e.g., wherein the inclusions make up to 70 wt. % or more, 80 wt. % or more, 90 wt. % or more, or even 100 wt. % of the droplets or composition/plume comprising the same) of the concentrations of the droplets or composition/plume comprising the same. In specific embodiments, such concentrations are achieved at any given distance from the nozzle, e.g., about 10 cm or more, about 15 cm or more, about 20 cm or more, about 25 cm or more, from the nozzle, or about halfway between the nozzle and the collector, ¾ of the way from the nozzle to the collector, or the like.

In some embodiments, a process or system provided herein allows for high throughput processing (e.g., relative to other non-gas controlled techniques). In some instances, the controlled air flow allows for an increase rate and uniformity in dispersion and/or breaking up of the jet and the plume, allowing for increased fluid stock flow rates, while also increasing deposition uniformity. In various embodiments, the fluid stock is provided to the nozzle at any suitable flow rate, such as about 0.01 mL/min or more, about 0.05 mL/min or more, about 0.1 mL/min or more, about 0.2 mL/min or more, or about 0.01 mL/min to about 10 mL/min. In certain embodiments, the fluid stock is provided to the first inlet at a rate of about 0.01 to about 10 mL/min, e.g., about 0.05 mL/min to about 5 mL/min, or about 0.5 mL/min to about 5 mL/min.

In specific embodiments, a process described herein comprises providing a fluid stock to a first inlet of a first conduit of a nozzle, the first conduit being enclosed along the length of the conduit by a wall having an interior surface and an exterior surface, the first conduit having a first outlet. In specific instances, the walls of the first conduit form a capillary tube, or other structure. In some instances, the first conduit is cylindrical, but embodiments herein are not limited to such configurations.

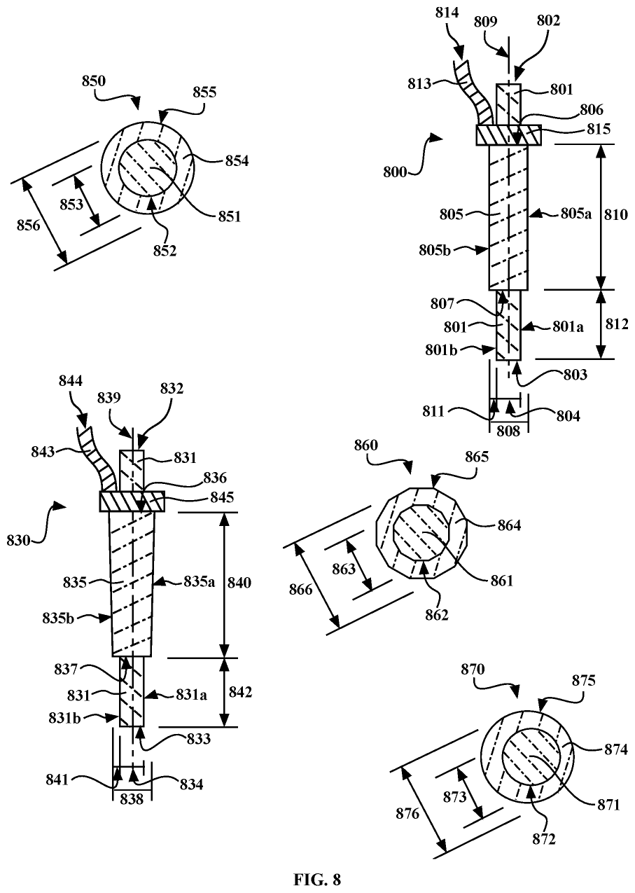

FIG. 8 illustrates exemplary nozzle apparatuses 800 and 830 provided herein. Illustrated by both nozzle components 800 and 830 some embodiments, the nozzle apparatus comprises a nozzle component comprising a first (inner) conduit, the first conduit being enclosed along the length of the conduit by a first wall 801 and 831 having an interior and an exterior surface, and the first conduit having a first inlet (or supply) end 802 and 832 (e.g., fluidly connected to a first supply chamber and configured to receive a fluid stock) and a first outlet end 803 and 833. Generally, the first conduit has a first diameter 804 and 834 (e.g., the average diameter as measured to the inner surface of the wall enclosing the conduit). In further instances, the nozzle component comprising a second (outer) conduit, the second conduit being enclosed along the length of the conduit by a second wall 805 and 835 having an interior and an exterior surface, and the second conduit having a second inlet (or supply) end 806 and 836 (e.g., fluidly connected to a second supply chamber and configured to receive a gas—such as a high velocity or pressurized gas (e.g., air)) and a second outlet end 807 and 837. In some instances, the second inlet (supply) end 806 and 836 is connected to a supply chamber. In certain instances, the second inlet (supply) end 806 and 836 are connected to the second supply chamber via a supply component. FIG. 8 illustrates an exemplary supply component comprising a connection supply component (e.g., tube) 813 and 843 that fluidly connects 814 and 844 the supply chamber (not shown) to an inlet supply component 815 and 845, which is fluidly connected to the inlet end of the conduit. The figure illustrates such a configuration for the outer conduit, but such a configuration is also contemplated for the inner and any intermediate conduits as well. Generally, the first conduit has a first diameter 808 and 838 (e.g., the average diameter as measured to the inner surface of the wall enclosing the conduit). The first and second conduits have any suitable shape. In some embodiments, the conduits are cylindrical (e.g., circular or elliptical), prismatic (e.g., a octagonal prism), conical (e.g., a truncated cone—e.g., as illustrated by the outer conduit 835) (e.g., circular or elliptical), pyramidal (e.g., a truncated pyramid, such as a truncated octagonal pyramid), or the like. In specific embodiments, the conduits are cylindrical (e.g., wherein the conduits and walls enclosing said conduits form needles). In some instances, the walls of a conduit are parallel, or within about 1 or 2 degrees of parallel (e.g., wherein the conduit forms a cylinder or prism). For example, the nozzle apparatus 800 comprise a first and second conduit having parallel walls 801 and 805 (e.g., parallel to the wall on the opposite side of the conduit, e.g., as illustrated by 801a/801b and 805a/805b, or to a central longitudinal axis 809). In other embodiments, the walls of a conduit are not parallel (e.g., wherein the diameter is wider at the inlet end than the outlet end, such as when the conduit forms a cone (e.g., truncated cone) or pyramid (e.g., truncated pyramid)). For example, the nozzle apparatus 830 comprise a first conduit having parallel walls 831 (e.g., parallel to the wall on the opposite side of the conduit, e.g., as illustrated by 831a/831b, or to a central longitudinal axis 839) and a second conduit having non-parallel walls 835 (e.g., not parallel or angled to the wall on the opposite side of the conduit, e.g., as illustrated by 835a/835b, or to a central longitudinal axis 839). In certain embodiments, the walls of a conduit are within about 15 degrees of parallel (e.g., as measured against the central longitudinal axis, or half of the angle between opposite sides of the wall), or within about 10 degrees of parallel. In specific embodiments, the walls of a conduit are within about 5 degrees of parallel (e.g., within about 3 degrees or 2 degrees of parallel). In some instances, conical or pyramidal conduits are utilized. In such embodiments, the diameters for conduits not having parallel walls refer to the average width or diameter of said conduit. In certain embodiments, the angle of the cone or pyramid is about 15 degrees or less (e.g., the average angle of the conduit sides/walls as measured against a central longitudinal axis or against the conduit side/wall opposite), or about 10 degrees or less. In specific embodiments, the angle of the cone or pyramid is about 5 degrees or less (e.g., about 3 degrees or less). Generally, the first conduit 801 and 831 and second conduit 805 and 835 having a conduit overlap length 810 and 840, wherein the first conduit is positioned inside the second conduit (for at least a portion of the length of the first and/or second conduit). In some instances, the exterior surface of the first wall and the interior surface of the second wall are separated by a conduit gap 811 and 841. In certain instances, the first outlet end protrudes beyond the second outlet end by a protrusion length 812 and 842. In certain instances, the ratio of the conduit overlap length-to-second diameter is any suitable amount, such as an amount described herein. In further or alternative instances, the ratio of the protrusion length-to-second diameter is any suitable amount, such as an amount described herein, e.g., about 1 or less.

FIG. 8 also illustrates cross-sections of various nozzle components provided herein 850, 860 and 870. Each comprises a first conduit 851, 861 and 871 and second conduit 854, 864, and 874. As discussed herein, in some instances, the first conduit is enclosed along the length of the conduit by a first wall 852, 862 and 872 having an interior and an exterior surface and the second conduit is enclosed along the length of the conduit by a second wall 855, 865 and 875 having an interior and an exterior surface. Generally, the first conduit has any suitable first diameter 853, 863 and 864 and any suitable second diameter 856, 866, and 876. The cross-dimensional shape of the conduit is any suitable shape, and is optionally different at different points along the conduit. In some instances, the cross-sectional shape of the conduit is circular 851/854 and 871/874, elliptical, polygonal 861/864, or the like.

In some instances, coaxially configured nozzles provided herein and coaxial gas controlled processing provided herein comprises providing a first conduit or fluid stock along a first longitudinal axis, and providing a second conduit or gas (e.g., pressurized or high velocity gas) around a second longitudinal axis (e.g., and electrospraying the fluid stock in a process thereof). In specific embodiments, the first and second longitudinal axes are the same. In other embodiments, the first and second longitudinal axes are different. In certain embodiments, the first and second longitudinal axes are within 500 microns, within 100 microns, within 50 microns, or the like of each other. In some embodiments, the first and second longitudinal axes are aligned within 15 degrees, within 10 degrees, within 5 degrees, within 3 degrees, within 1 degree, or the like of each other. For example, FIG. 8 illustrates a cross section of a nozzle component 870 having an inner conduit 871 that is off-center (or does not share a central longitudinal axis) with an outer conduit 874. In some instances, the conduit gap (e.g., measurement between the outer surface of the inner wall and inner surface of the outer wall) is optionally averaged—e.g., determined by halving the difference between the diameter of the inner surface of the outer wall 876 and the diameter of the outer surface of the inner wall 872. In some instances, the smallest distance between the inner surface of the outer wall 876 and the diameter of the outer surface of the inner wall 872 is at least 10% (e.g., at least 25%, at least 50%, or any suitable percentage) of the largest distance between the inner surface of the outer wall 876 and the diameter of the outer surface of the inner wall 872.

In some embodiments, the polymer has any suitable molecular weight. For example, in certain embodiments, the polymer has a molecular weight of at least 5,000 atomic mass units (“amu”), at least 10,000 amu, at least 20,000 amu, at least 50,000 amu, and the like. A polymer in used in a process or found in a composition herein has any suitable PDI (weight average molecular weight divided by the number average molecular weight). In some embodiments, the polymer has a polydispersity index of about 1 to about 10, about 2 to about 5, about 1 to about 5, or the like.

In certain embodiments, any suitable amount of polymer is optionally utilized in a fluid stock provided herein. In some instances, the amount of polymer utilized is less than the amount that would inhibit the formation of a plume (dispersion and/or breaking-up of the jet) when being sprayed. In some instances, with the use of the gas controlled spray processes, greater amounts of polymer are optionally utilized when compared to conventional spray techniques because of the effect of the gas to further break-up the jet and/or plume, providing greater formation, dispersion and control of droplets. In certain embodiments, the amount of polymer present in the fluid stock is less than 10 wt. %. In more specific embodiments, the amount of polymer present in the fluid stock is 0 wt. % to about 5 wt. % (e.g., about 0.1 wt. % to about 5 wt. %, or about 0.5 wt. % to about 5 wt. %). In other instances, the amount of polymer utilized is at least the amount that is required to result in the formation of a jet and a fiber, without forming a plume (e.g., dispersion and/or breaking-up of the jet) when being spun. In some instances, with the use of the gas controlled spin processes, greater amounts of polymer are optionally utilized when compared to conventional spin techniques because of the effect of the gas to further improve processing capabilities and throughput. In certain embodiments, the amount of polymer present in the fluid stock is at least about 5 wt. %. In more specific embodiments, the amount of polymer present in the fluid stock is at least 10 wt. %. In still more specific embodiments, the amount of polymer present in the fluid stock is about 5 wt. % to about 50 wt. % (e.g., about 10 wt. % to about 50 wt. %, or about 10 wt. % to about 30 wt. %).

In certain embodiments, the liquid medium comprises any suitable solvent or suspending agent. In some embodiments, the liquid medium is merely utilized as a vehicle and is ultimately removed, e.g., by evaporation during the spray or spin (e.g., electrospray or electrospin) process and/or upon drying of the deposition. In certain embodiments, the liquid medium comprises water, an alcohol (e.g., methanol, ethanol, isopropanol, propanol, butyl alcohol, or the like), dimethylformamide (DMF), tetrahydrofuran (THF), Dimethylacetamide (DMAc), N-methyl-pyrrolidone (NMP), or a combination thereof. In certain embodiments, the liquid medium comprises a liquid precursor material that is converted upon deposition to a desired material, such as a ceramic. In some specific embodiments, the liquid medium comprises polysilazane, a silsesquioxone (e.g., polyhedral oligomeric silsesquioxane (POSS), or polysilsesquioxane (PSSQ)), or a combination thereof. In some instances, unless otherwise stated, the ceramic precursor optionally fulfills the role of both liquid medium and ceramic precursor. In specific (e.g., preferred) instances, the ceramic precursor does not fulfill the role of liquid medium.

In some embodiments, the ceramic precursor is a polysilazane, such as having a structure of general formula (I′):

—[SiR^{1′}R^{2′}—NR^{3′}]ₙ— (I′)

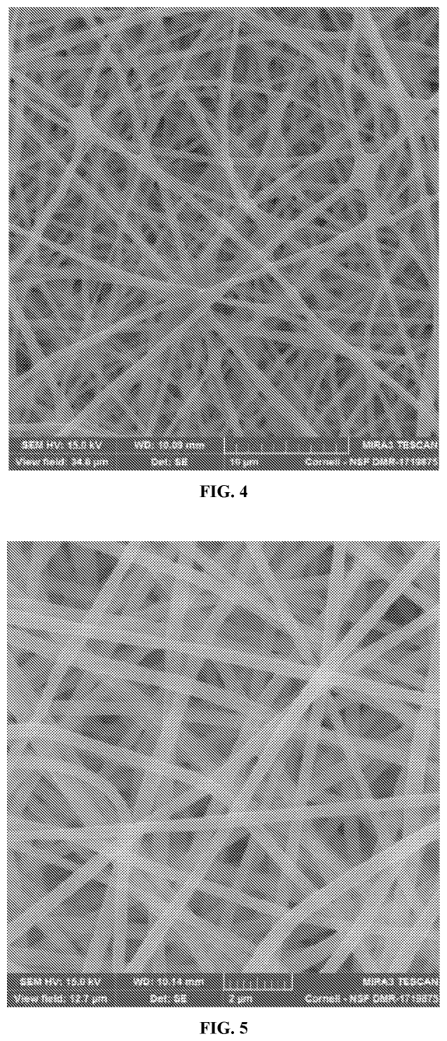

In some instances, the polysilazane has a chain, cyclic, crosslinked structure, or a mixture thereof. FIG. 5 illustrates an exemplary silazane structure having a plurality of units of Formula I′ with cyclic and chain structures. In various embodiments, the polysilazane comprises any suitable number of units, such as 2 to 10,000 units and/or n is any suitable value, such as an integer between 2 and 10,000. In certain embodiments, the polysilazane of formula I has an n value such that the 100 to 100,000, and preferably from 300 to 10,000. Additional units are optionally present where each R^{1′} or R^{2′} is optionally cross-linked to another unit at the N group—e.g., forming, together with the R^{3′} of another unit a bond—such cross-links optionally form links between separate linear chains, or form cyclic structures, or a mixture thereof. In an exemplary embodiment, a compound of formula I comprises a plurality of units having a first structure, e.g., —[SiHCH₃—NCH₃]—, and a plurality of units having a second structure, e.g., —[SiH₂NH]—. In specific embodiments, the ratio of the first structure to the second structure is 1:99 to 99:1. Further, in certain embodiments, the compound of Formula I′ optionally comprises a plurality of units having a third structure, such as wherein the ratio of the first structure to the third structure is 1:99 to 99:1. The various first, second, and optional third structures may be ordered in blocks, in some other ordered sequence, or randomly. In specific embodiments, each R^{1′}, R^{2′}, and R^{3′} is independently selected from H and substituted or unsubstituted hydrocarbon, such as alkyl (straight chain, branched, cyclic or a combination thereof; saturated or unsaturated). Exemplary, polysilazanes provided herein comprise one or more unit of FIG. 15, wherein x, y, and z are individually any suitable integer, such as 1 to about 100 or 1 to about 1,000 or more, and R is as described above for R^{1′} or R^{2′}.

In some embodiments, the ceramic precursor is a silsesquioxane, such as having a structure of general formula (II′):

—[SiR^{1′}R^{2′}—O]ₙ— (II′)

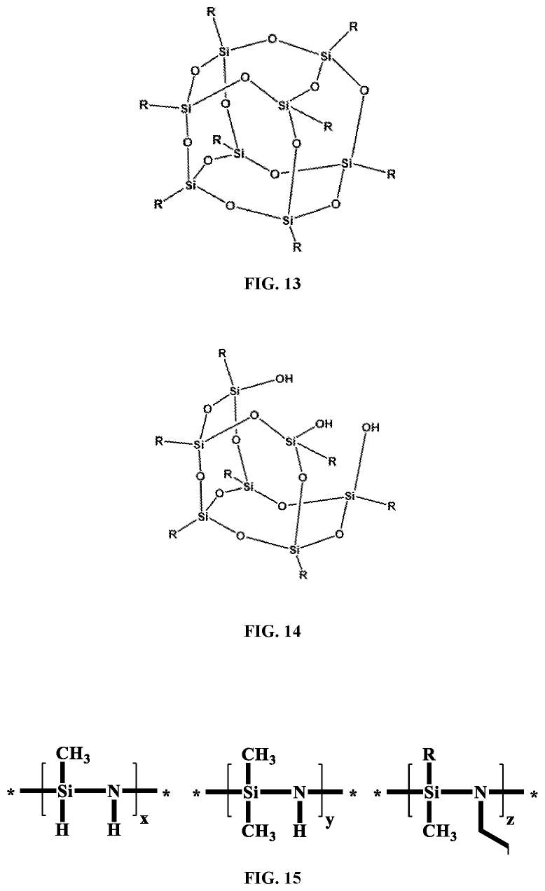

In some instances, the compound is a silsesquioxane having a cage (e.g., polyhedral oligomeric) or opened cage (e.g., wherein an SiR^{1′} is removed from the cage) structure. FIG. 13 illustrates an exemplary cage wherein n is 8 (wherein the R group of FIG. 13 is defined by R¹ herein). FIG. 14 illustrates an exemplary opened cage wherein n is 7 (wherein the R group of FIG. 14 is defined by R^{1′} herein). In some instances, an R¹ or R² group of one unit is taken together with an R^{1′} or R^{2′} group of another unit to form an —O—. In certain embodiments, a cage structure is optionally formed when several an R¹ or R^{2′} groups are taken together with the R^{1′} or R^{2′} groups of other units (e.g., as illustrated in FIG. 13). In various embodiments, the polysilazane comprises any suitable number of units, such as 2 to 20 units and/or n is any suitable value, such as an integer between 2 and 20, e.g., 7-16. In certain embodiments, the cage comprises 8 units, but larger cages are optional. In additional, opened cages, wherein one of the units is absent are also optional.

In some embodiments, the ceramic precursor is a polysilsesquioxane (PSSQ), such as having a structure of general formula (III′):

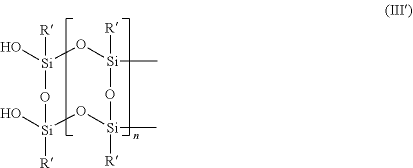

In certain embodiments, each R′ is independently H or substituted or unsubstituted hydrocarbon, such as alkyl (e.g., substituted or non-substituted, such as with alkyl, heteroalkyl, aryl, heteroaryl, hydroxyl, halo, carboxy, COOR, OCOR, or the like, such as wherein R is H, alkyl, or heteroalkyl, such as wherein R is alkyl).

In various embodiments, any substituted radicals may be substituted with halogens such as chlorine, bromine and fluorine, an alkoxy group, an alkoxycarbonyl group, a silyl group, an amino group, alkyl, heteroalkyl, aryl, heteroaryl, hydroxyl, halo, carboxy, COOR, OCOR, (such as wherein R is H, alkyl, or heteroalkyl), a siloxane, an organosiloxane, a silsesquioxane, an organosilsesquioxane, a POSS group (e.g., comprising one or more of the structural units: RSiO_{1.5}, wherein R is, e.g., a hydrocarbon), a silane, an organosilane, or other silicon containing substituents. In some instances, radicals may be taken together to form a ring. The hydrocarbon group includes an aliphatic hydrocarbon group and an aromatic hydrocarbon group, and the aliphatic hydrocarbon group may include a chain hydrocarbon group and a cyclic hydrocarbon group. Examples of the hydrocarbon group include an alkyl group, an alkenyl group, a cycloalkyl group, a cycloalkenyl group, an aryl group, and an arylalkyl group. Alkyl groups described herein include saturated, unsaturated, straight-chain, branched, and cyclic alkyl groups (as well as groups comprising combinations thereof). The number of carbon atoms in these hydrocarbon atoms is not limited, but is usually 20 or less, and preferably 10 or less. In the present invention, preferred is an alkyl group having 1 to 8 carbon atoms, and particularly 1 to 4 carbon atoms. In the hydrocarbon group-containing silyl group, a preferable hydrocarbon group is an alkyl group having 1 to 20 carbon atoms, and particularly 1 to 6 carbon atoms. In specific instances, the number of hydrocarbon atoms to be combined with Si is within a range from 1 to 3. In specific instances, the hydrocarbon containing amino group and hydrocarbonoxy group, the number of carbon atoms in the hydrocarbon group is within a range from 1 to 3.

Ceramic precursors provided herein may have a chain, cyclic or crosslinked structure, or a mixture thereof. Additional units may be present where each substituent (R type group) is optionally cross-linked to another monomeric unit of the general formula (e.g., at the N group for silazanes—e.g., through R^{3′}—such cross-links may form links between separate linear chains, or form cyclic structures, or a mixture thereof). Any suitable molecular weight for such ceramic precursors is contemplated herein, such as wherein the number-average molecular weight is within a range from 100 to 100,000, e.g., from 300 to 10,000.

In some embodiments, a process herein comprises or a system provided herein is configured to provide a voltage to a nozzle, such as one provided herein. In specific embodiments, the voltage is provided to the inner conduit (e.g., the walls thereof). In certain embodiments, application of the voltage to the nozzle provides an electric field at the nozzle (e.g., at the outlet of the inner conduit thereof). In some instances, the electric field results in the formation of a “cone” (e.g., Taylor cone) at the nozzle (e.g., at the outlet of the first/fluid stock conduit thereof), and ultimately a jet and/or plume/aerosol. In certain instances, after the formation of a cone, the jet is broken up into small and highly charged liquid droplets, which are dispersed, e.g., due to Coulomb repulsion.

In certain embodiments, a process herein provides or a system herein is configured to provide a pressurized gas to an outer inlet of an gas/second conduit of a nozzle. In some embodiments, the gas conduit is enclosed along the length of the conduit by an outer wall having an interior surface, the gas conduit having an gas conduit inlet and an gas conduit outlet. In some instances, the pressurized gas is provided from a pressurized canister, by a pump, or by any other suitable mechanism. Generally, providing pressurized gas to a nozzle (e.g., to the inlet of the outer channel) results in a high velocity gas being discharged from the nozzle (e.g., outlet of the outer channel of the nozzle). Any suitable gas pressure or gas velocity is optionally utilized in processes and/or systems herein. In specific embodiments, the gas pressure applied (e.g., to the inlet of the outer channel) is about 15 psi or more. In more specific embodiments, the gas pressure is about 20 psi or more, about 25 psi or more, or about 40 psi or more. In certain embodiments, the velocity of the gas at the nozzle (e.g., the outlet of the outer channel thereof) is about 0.5 m/s or more, about 1 m/s or more, about 5 m/s or more, about 25 m/s or more, or the like. In more specific embodiments, the velocity is about 50 m/s or more. In still more specific embodiments, the velocity is about 100 m/s or more, e.g., about 200 m/s or more, or about 300 m/s. In certain embodiments, the gas is any suitable gas, such as comprising air, oxygen, nitrogen, argon, hydrogen, or a combination thereof.

In certain embodiments, the fluid stock/first and gas/second conduits have any suitable configuration, such as diameter. In some embodiments, the fluid stock conduit length, the gas conduit length, and the conduit overlap length is about 0.1 mm to about 100 mm, or more. In specific embodiments, the fluid stock conduit length, the gas conduit length, and the conduit overlap length is about 0.5 mm to about 100 mm, e.g., about 1 mm to about 100 mm, about 1 mm to about 50 mm, about 1 mm to about 20 mm, or the like. In certain embodiments, the ratio of the conduit overlap length to the fluid stock conduit diameter being about 0.5 to about 10, e.g., about 1 to about 10. In some embodiments, the fluid stock conduit is longer than the gas conduit. In certain embodiments, the fluid stock conduit protrudes beyond the gas conduit, or vice versa. In some embodiments, the protrusion length (e.g., channel terminus offset) of the fluid stock conduit is about −0.5 mm to about 1.5 mm, e.g., about 0 mm to about 1.5 mm.

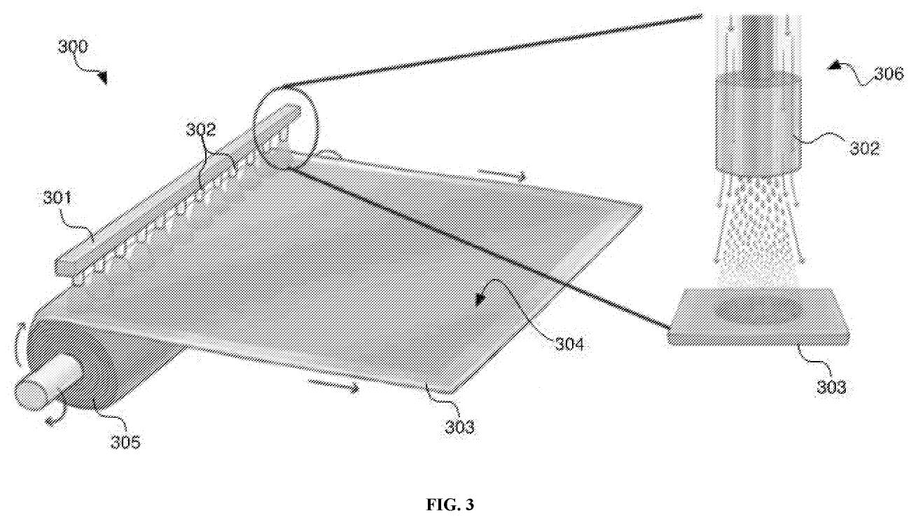

In certain embodiments, processes herein comprise collecting and/or systems herein are configured to collect (e.g., micron or sub-micron scaled) particles and/or droplets of the plume onto a membrane of nanofiber mat substrate. In specific embodiments, collection of these materials allows for the formation of a uniform deposition on the substrate. Further, in some instances, given the small size of the deposition components (e.g., particles and/or droplets) formed by systems and processes described herein, it is possible to form depositions having thin and/or uniform layers, and to have good control of the thickness thereof. In some embodiments, the substrate is positioned opposite the outlet of the nozzle. FIG. 3 illustrates an exemplary system 300 provided herein comprising a bank 301 of electrospray nozzles 302 positioned opposite a substrate 303. FIG. 3 also illustrates an exploded view 306 of a nozzle 302 and a substrate 303. As is exemplarily illustrated in FIG. 3, spraying/spinning (e.g., electrospraying or electrospinning) a fluid stock onto a substrate forms a deposition 304 thereon. In some embodiments, the substrate and/or the nozzle bank is configured to be mobile, allowing facile deposition onto a substrate. As illustrated in FIG. 3, the substrate 303 is optionally configured to be affixed to a roll 305, and/or the nozzle bank is configured to move along the surface of a substrate, depositing a coating on the substrate as the bank moves. In specific embodiments, the substrate is itself grounded or positioned between a grounded component (the “collector”) and the nozzle. Alternatively, a voltage, such as described herein, is applied to the “collector” and the nozzle is grounded.

Further, in some embodiments, it is desirable that any inclusions in the fluid stock are dissolved and/or well dispersed prior to processing, e.g., in order to minimize clogging of the nozzle, ensure good uniformity of dispersion of any inclusions in the resulting deposition, and/or the like. In specific embodiments, the fluid stock is agitated prior to being provided to the nozzle (e.g., inner conduit inlet thereof), or the system is configured to agitate a fluid stock prior to being provided to the nozzle (e.g., by providing a mechanical stirrer or sonication system associated with a fluid stock reservoir, e.g., which is fluidly connected to the inlet of the inner conduit of an electrospray nozzle provided herein).

### EXAMPLES

### Example 1: Ceramic-Polymer Separator Membrane

A ceramic precursor stock comprising 0.5-2 wt. % PSSQ as ceramic precursor in ethanol is prepared. Alternate stocks utilizing about 10% PSSQ in DMF are also utilized. The solution is provided to a gas-controlled electrospray nozzle, to which a direct voltage is maintained. A grounded collector is positioned opposite the electrospray nozzle, at a distance of about 20 cm to about 25 cm. A nanofiber mat comprising polyimide nanofibers (P84) is configured between on the surface of the grounded collector, opposite the electrospray nozzle. About 5-10 mL of ceramic precursor stock is sprayed onto the nanofiber mat at a flow rate of about 0.5 mL/min. Following collection of ceramic precursor on the polymer nanofibers, the coated nanofiber mat is dried at about 200° C. The nanofiber mats are then calendered to a thickness of about 25 micron and cured at a temperature of about 300° C. Cured and calendered membranes can be readily handled, are flexible (textile-like), and are not brittle.

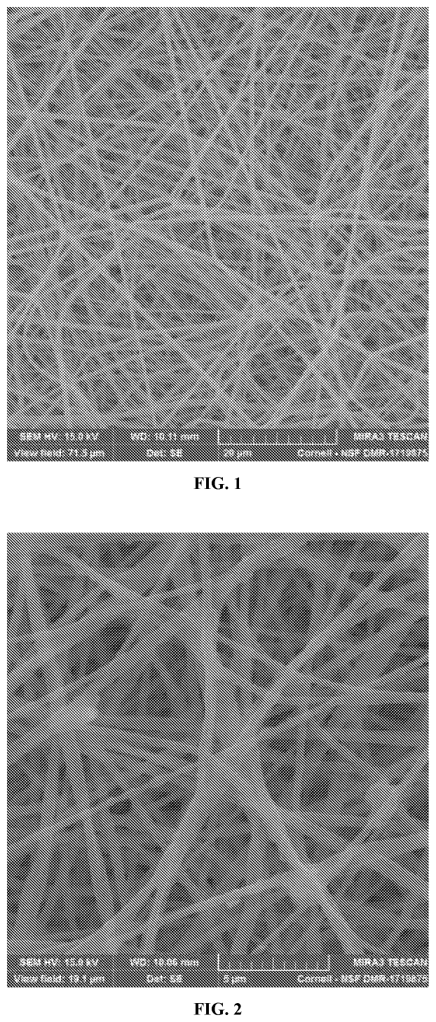

FIG. 1 illustrates a scanning electron microscopy (SEM) image of a first membrane surface (top) onto which 6 mL of ceramic precursor stock was deposited (and cured). FIG. 2 illustrates an SEM image of a second surface (bottom) onto which 6 mL of ceramic precursor stock was deposited (and cured) on the opposite surface. FIG. 4 illustrates a scanning electron microscopy (SEM) image of a first membrane surface (top) onto which 10 mL of ceramic precursor stock was deposited (and cured). FIG. 5 illustrates an SEM image of a second surface (bottom) onto which 10 mL of ceramic precursor stock was deposited (and cured) on the opposite surface. Heavy loading of ceramic on the nanofiber mats is observed, with ceramic nanofiber junctions observed in the coated sides of the membranes, with many such junctions readily observed in FIG. 4.

While nanofiber diameters of were about the same on the top and bottom of the membrane prior to deposition of the ceramic precursor, following deposition and curing of the ceramic precursor, significant size differences were observed between the coated surface and the back surface (i.e., opposite the coated surface), as illustrated in Table 1.

TABLE 1

| | | |
|---|---|---|
| Sample | Surface | Avg. Diameter (nm) |

| | | | |
|---|---|---|---|
| 6 | mL | Coated | 726 |
| 6 | mL | Back | 434 |
| 10 | mL | Coated | 535 |
| 10 | mL | Back | 395 |

### Example 2: Lithium Ion Battery/Ceramic-Polymer Separator Membrane

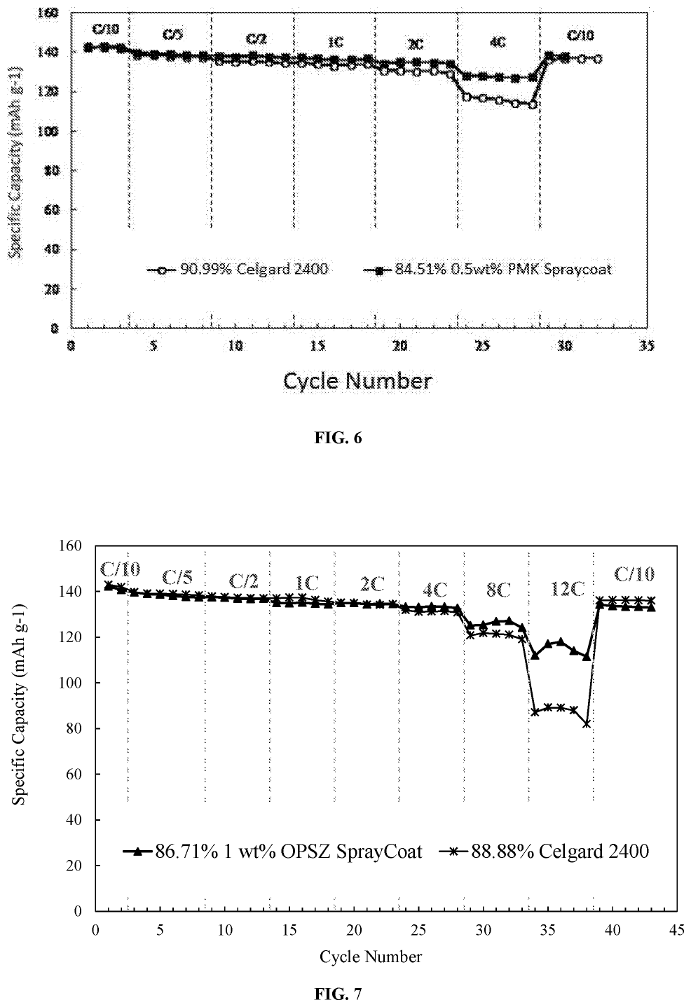

Lithium ion battery full cell with high loading of electrode material (lithium metal oxide cathode and graphite anode) is manufactured using a separator described in Example 1. A similar cell is prepared using CELGARD® 2400 (porous polyolefin film). FIG. 6 illustrates the specific capacities of both cells. As illustrated, the capacity of the polymer-ceramic hybrid membrane separator demonstrates comparable capacity at low rates as the CELGARD® material, but significantly higher capacity at higher rates (e.g., 2 C and 4 C). Moreover, at the higher rates, the CELGARD® material is observed to begin to have significant capacity decline during cycling. In addition, the polymer-ceramic hybrid membrane separator materials provided herein also demonstrate a much better safety profile than the CELGARD® material, with improved thermal stability and non-flammable characteristics.

### Example 3: Flammability/Ceramic-Polymer Separator Membrane

An electrolyte solution of 1 molar LiPF6 in 4:2:4 EC:DMC:DEC (ethyl, dimethyl, diethyl carbonate) is prepared. A sample of separator membrane from Example 1 is provided. The separator membrane is soaked in the electrolyte solution. The electrolyte solution is lit on fire. Following extinguishing the fire, the separator membrane is observed to remain intact and flexible.

The test was similarly performed with the CELGARD® 2400 material, as used in Example 2, with the CELGARD® separator material melting. For comparison purposes, polyimide P84 nanofibers used in Example 1 were similarly tested without a ceramic coating being applied by a process of Example 1. Polyimide (P84) nanofibers thermally treated at a temperature of about 200° C. prior to the flammability test resulted in the nanofibers burning up and melting. Polyimide nanofibers thermally treated at a temperature of about 300° C. prior to the flammability tested resulted in the nanofibers becoming extremely brittle. A nanofiber mat of Example 1 was also prepared omitting the final thermal treatment of 300° C. Such (less cured) material was also observed to burn up/melt when subjected to the flammability test.

### Example 4: Ceramic-Polymer Separator Membrane

Using a process similar to that in Example 1, a separator membrane is manufactured using polyimide (P84) polymer nanofiber mat and organopolysilazane (OPSZ) as ceramic precursor. Similar resistance to combustion and degradation in flame as observed in Example 2 were also observed.

Lithium ion battery full cell with lower loading (half that of Example 2) of electrode material (lithium metal oxide cathode and graphite anode) is manufactured using the separator as describe in Example 2. A similar cell is prepared using CELGARD® 2400 (porous polyolefin film). FIG. 7 illustrates the specific capacities of both cells. It is noted that at 4 C with the lower electrode loading, the polyolefin film separator performs fairly well, comparably to the polymer-ceramic hybrid membrane described herein. However, at higher rates, such as 12 C, the instant polymer-ceramic hybrid membrane still performs well, whereas the porous polyolefin film separator begins to show significant capacity loss.

As illustrated, the capacity of the polymer-ceramic hybrid membrane separator demonstrates comparable capacity at low rates as the CELGARD® material, but significantly higher capacity at higher rates (e.g., 12 C). In addition, the polymer-ceramic hybrid membrane separator materials provided herein also demonstrate a much better safety profile than the CELGARD® material, with improved thermal stability and non-flammable characteristics.

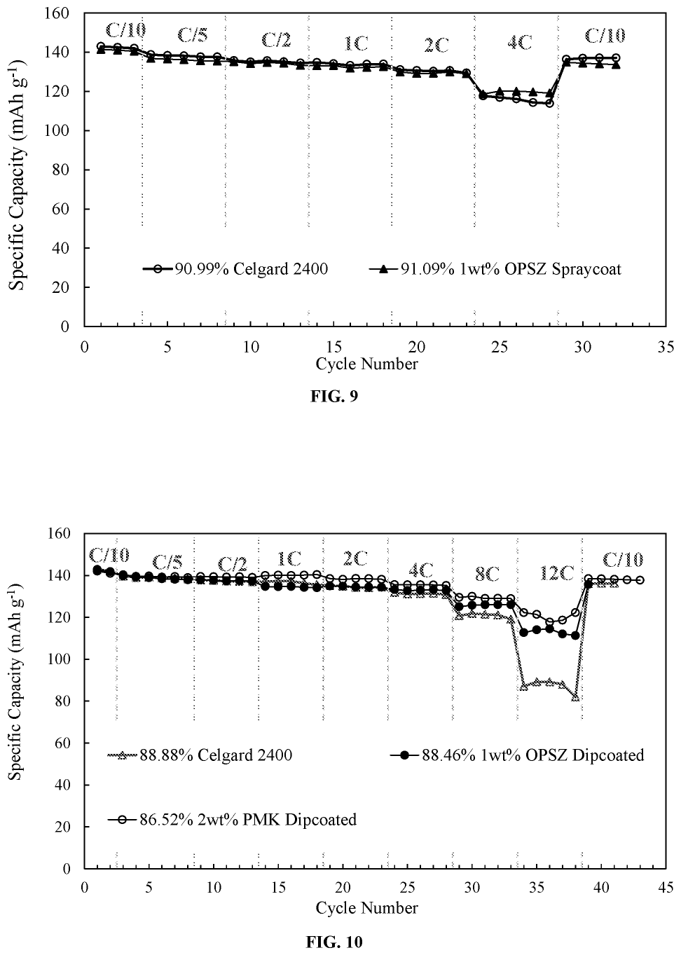

Using higher electrode loading cells, such as described in Example 2, good results are also observed, with the separator membranes of Example 4 showing comparable capacities to those observed for polyolefin separators, with improved performance at higher rates (e.g., 4 C), as illustrated in FIG. 9.

### Example 5: Ceramic-Polymer Separator Membrane—Dipcoating

Similar materials to those described in Examples 1 and 4 are prepared by soaking nanofiber mats with the ceramic precursor fluid stocks therein, rather than by spraying them. This approach serves to well coat the nanofibers of the mat throughout the nanofiber mat, but is not readily scalable and does not afford the degree of deposition control observed when using the spray techniques described herein.

Full cells are prepared according to Example 4, including those using a polyolefin separator film (CELGARD® 2400), and ceramic-polymer hybrid membranes prepared from PSSQ and OPSZ. FIG. 10 illustrates good capacity parameters of the PSSQ (PMK) and OPSZ derived separator membrane relative to the polyolefin separator, and demonstrates the improved rate capability when compared to the polyolefin separator. Moreover, FIG. 10 demonstrates the slight improvement of PSSQ over OPSZ derived materials, particularly at higher rates.

Flammability tests are also performed for the dip-coated membranes, according to the procedures described in Example 3. As with the spray coated membranes, membranes dried at lower temperature burned up/melted, whereas spray coated membranes more fully cured (e.g., at a temperature of about 300° C.) remained intact and flexible.

### Example 6: Electrospin Ceramic-Polymer Hybrid Nanofibers

A fluid stock is prepared by dissolving polyimide (P84) and ceramic precursor (OPSZ) in DMF. The solution is provided to a gas-controlled electrospin nozzle, to which a direct voltage of about 10 kV to about 15 kV is maintained. A grounded collector is positioned opposite the electrospin nozzle, at a distance of about 20 cm to about 25 cm. In some instances, the spinning jet self-organized, such that nanofibers comprising a core material comprising a continuous polymer matrix, with ceramic embedded therein, and a ceramic shell surrounding the core material.

The difficulty with this procedure, however, is that the polyimide/OPSZ have a tendency to react in such a way as to rapidly gel when combined in spinning concentrations. At various polymer concentrations (e.g., 15 wt. %, 14 wt. %, 12 wt. %, and 10 wt. %, polyimide:OPSZ (80:20)) samples were all observed to quickly gel to such a point that spinning was not possible after more than a couple of minutes. Other ratios, including ratios of 83:17, 84:16, 86:14, 87:13, and 90:10 were all observed to gel within a few minutes to a few hours. As such, while workable on a small scale, such rapid gelling is difficult to manage on a commercial scale. Higher polymer content solutions, such as 92:8 gelled slower (e.g., if left overnight), whereas 95:5 solutions gelled even slower or not at all. In addition, solutions of about 10 to about 11 wt. % ceramic precursor (OPSZ) initially spun well, but raising the concentrations (in the presence of the polyimide) caused quick gelling. Moreover, when fibers are electrospun, they can be sticky and difficult to handle or manage. Similar or worse results were obtained when using spin solutions of polyimide with PSSQ, with substantial clogging issues being observed, even when using gas assisted electrospinning.

Full cells are prepared according to Example 4 (lower electrode loading), including those using a polyolefin separator film (CELGARD® 2400), and ceramic-polymer hybrid membranes prepared from OPSZ (spun in a polymer:OPSZ weight ratio of 90:10—as discussed above, such stocks are difficult to process and gel quickly).

As illustrated in FIG. 11, the membranes comprising cured OPSZ shelling of polyimide fibers produce similarly good results, whether such nanofiber mats are produced by co-spinning precursor (Example 6) with polyimide or dip-coating (Example 5) the polyimide in ceramic precursor, with both demonstrating significantly better results than that observed for the polyolefin film (CELGARD® 2400), particularly at higher rates. Similarly good results were obtained for polymer-ceramic hybrid nanofibers produced from a polymer (P84):precursor (OPSZ) weight ratio of 92:8, but poor results were obtained when a ratio of 95:5 was utilized.

Ceramic-polymer hybrid nanofibers (90:10) are also tested using the flammability test described in Example 3, with the OPSZ/polyimide (P84) dried at 200° C. burning up or melting and the OPSZ/polyimide (P84) cured at 300° C. remaining intact and flexible.

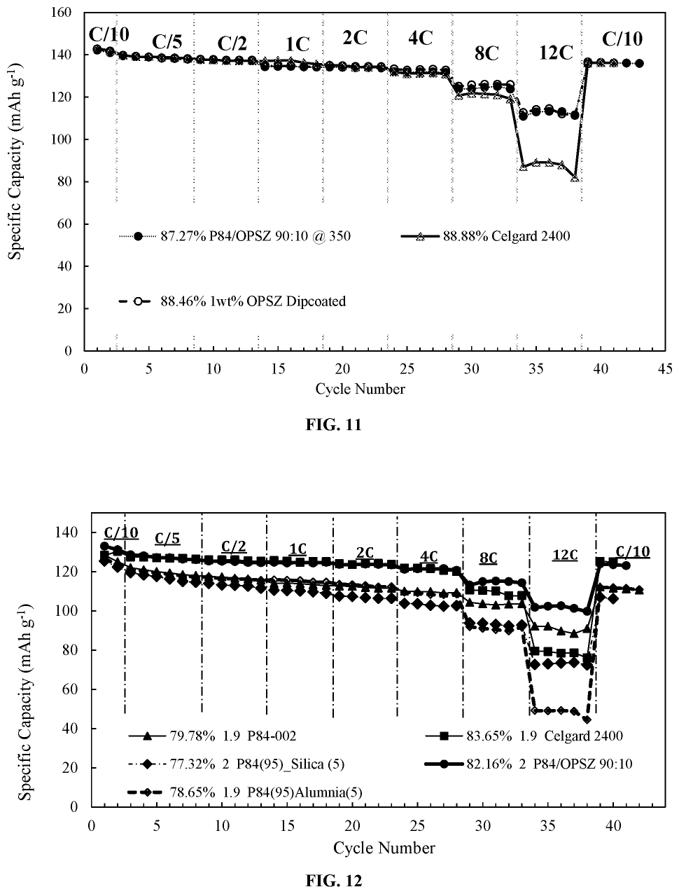

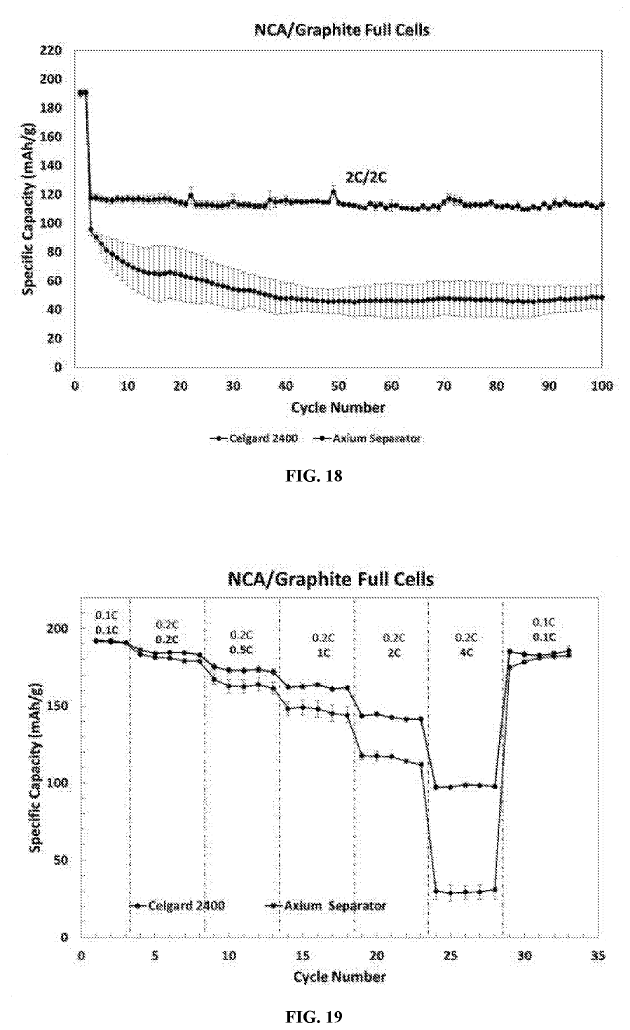

For comparison, naked polyimide (P84) nanofibers and polymer-ceramic composite nanofibers are prepared using gas-assisted electrospinning of polymer and ceramic (silica or alumina) nanoparticles in a 95:5 weight ratio. Generally, composite nanofibers produced comprise a continuous polymer matrix, with well dispersed ceramic particles embedded therein (no continuous ceramic shell). FIG. 12 illustrates inferior results in capacity and rate capability for polymer-ceramic composite materials with no fiber shelling relative to the polyolefin separator film cells. Indeed, the naked polyimide fibers showed better results, but not as good as the results observed for the ceramic shelled fiber materials. Moreover, inferior first cycle Coulombic efficiencies were observed in the cells comprising naked polyimide separator membranes (less than 80%) relative to both the polyolefin film membranes and the membranes comprising shelled nanofibers (typically well over 80-90%).

Whereas FIG. 12 illustrates results of 90:10 polyimide/OPSZ samples, FIG. 18 illustrates the capacity retention of 92:8 polyimide/OPSZ samples. As illustrated, excellent capacities and capacity retentions are achieved. It is noted that these results are achieved even when using highly loaded cells, with a loading of 3 mAh/cm² full cells, and cycling at high rates 2 C charge and discharge rates. Further, FIG. 19 demonstrates the excellent rate capabilities of such separator membranes. Manufacture of similar cells using a coated separator similar to that described in Example 1 produced cells with even better capacity (e.g., increased capacity of about 5-10 mAh/g on average).

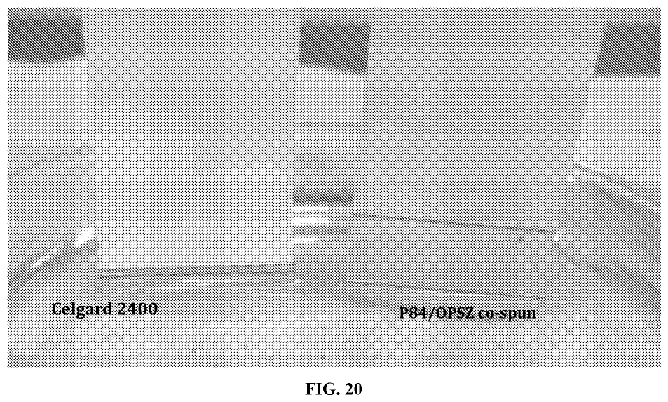

Moreover, FIG. 20 illustrates the greatly improved wettability/wicking of the membranes prepared according to this example over conventional CELGARD® 2400 polyolefin separator materials. Such improved abilities allow for lesser quantities of electrolyte to be utilized in a cell, thereby decreasing environmental impact and reducing cost of cell manufacturing. Manufacture of similar cells using a coated separator similar to that described in Example 1 produced cells with similar rate capabilities.

What is claimed is:

1. A thermally stable, flame-resistant polymer-ceramic battery separator membrane, the separator membrane comprising a nanofiber mat, the nanofiber mat comprising one or more shelled nanofiber(s), the one or more shelled nanofiber comprising a continuous core material and a continuous shell material, the continuous core material comprising a polymer, and the continuous shell material comprising a ceramic.

2. A separator membrane comprising a nanofiber mat, the nanofiber mat comprising one or more nanofiber, the one or more nanofiber comprising a continuous matrix of polymer, the polymer comprising a polyimide.

3. A thermally stable, flame-resistant polymer-ceramic battery separator membrane, the separator membrane comprising a nanofiber mat, the nanofiber mat comprising one or more nanofiber(s);
the one or more nanofiber(s) comprising a continuous matrix of polymer;
the separator membrane having a first membrane surface and a second membrane surface;
a first portion of the one or more nanofiber(s) being at and in proximity to) the first membrane surface, a second portion of the one or more nanofiber(s) being at and in proximity to the second membrane surface, and a third portion of the one or more nanofiber(s) being configured between the first and second membrane surfaces; and
the first portion of the one or more nanofiber(s) comprising one or more shelled nanofiber segment(s), the one or more shelled nanofiber segment(s) comprising a continuous shell material (e.g., in surrounding relation to a continuous core material), the continuous shell material comprising a ceramic, and the continuous matrix of polymer forming a continuous core material of the shelled nanofiber segment(s).

4. The separator membrane of any one of the preceding claims, wherein the first portion of the one or more nanofiber(s) comprises a plurality of nanofiber junctions, each nanofiber junction joining two or more intersecting shelled nanofiber segment(s) of the first domain.

5. The separator membrane of any one of the preceding claims, wherein the nanofiber junction comprises a ceramic (e.g., same as the ceramic of the shell).

6. The separator membrane of any one of the preceding claims, wherein the ceramic concentration of the first domain is higher than the ceramic concentration (e.g., ceramic weight relative to the polymer weight of the domain, or of the overall weight of the domain) of the second domain and/or the third domain.

7. The separator membrane of any one of the preceding claims, wherein the ceramic concentration of the first domain is at least 1 percentage point by weight, relative to the polymer weight, higher than the ceramic concentration of the second and/or third domain(s).

8. The separator membrane of any one of the preceding claims, wherein the ceramic concentration of the first domain is at least 2 percentage point by weight, relative to the polymer weight, higher than the ceramic concentration of the second and/or third domain(s).

9. The separator membrane of any one of the preceding claims, wherein the ceramic concentration of the first domain is at least 5 percentage point by weight, relative to the polymer weight, higher than the ceramic concentration of the second and/or third domain(s).

10. The separator membrane of any one of the preceding claims, wherein the first domain extends at least 0.1 micron into the separator membrane.

11. The separator membrane of any one of the preceding claims, wherein the first domain extends at least 0.2 micron into the separator membrane.

12. The separator membrane of any one of the preceding claims, wherein the first domain extends at least 0.5 micron into the separator membrane.

13. The separator membrane of any one of the preceding claims, wherein the second portion of the one or more nanofiber(s) comprises one or more second shelled nanofiber segment(s), the one or more second shelled nanofiber segment(s) comprising a continuous shell material, the continuous shell material comprising a ceramic, and the continuous matrix of polymer forming a continuous core material of the second shelled nanofiber segment(s).

14. The separator membrane of any one of the preceding claims, the separator membrane having a porosity of about 10% to about 70%.

15. The separator membrane of any one of the preceding claims, the separator membrane having an average thickness of about 1 micron to about 25 micron.

16. The separator membrane of any one of the preceding claims, the separator membrane having a thickness variation of less than 20%.

17. The separator membrane of any one of the preceding claims, the separator membrane having a plurality of pores therethrough, wherein fewer than 5% of the pores have a size of less than 1 micron (a pore distribution d95 of less than 1 micron).

18. The separator membrane of any one of the preceding claims, wherein the ceramic (e.g., of the continuous shell material and nanofiber junctions) constitutes about 1 wt. % to about 50 wt. % of the nanofiber mat.

19. The separator membrane of any one of the preceding claims, wherein the ceramic (e.g., of the continuous shell material and nanofiber junctions) constitutes about 3 wt. % to about 30 wt. % of the nanofiber mat.

20. The separator membrane of any one of the preceding claims, wherein the ceramic (e.g., of the continuous shell material and nanofiber junctions) constitutes about 5 wt. % to about 15 wt. % of the nanofiber mat.

21. The separator membrane of any one of the preceding claims, wherein the polymer constitutes about 50 wt. % to about 99 wt. % of the nanofiber mat.

22. The separator membrane of any one of the preceding claims, wherein the polymer constitutes about 70 wt. % to about 99 wt. % of the nanofiber mat.

23. The separator membrane of any one of the preceding claims, wherein the polymer is a non-flammable polymer.

24. The separator membrane of any one of the preceding claims, wherein the polymer has a limiting oxygen index (LOI) of at least 21%.

25. The separator membrane of any one of the preceding claims, wherein the polymer has a limiting oxygen index (LOI) of at least 25%.

26. The separator membrane of any one of the preceding claims, wherein the polymer has a limiting oxygen index (LOI) of at least 30%.

27. The separator membrane of any one of the preceding claims, wherein the polymer has a limiting oxygen index (LOI) of at least 35%.

28. The separator membrane of any one of the preceding claims, wherein the polymer is a thermally-stable polymer.

29. The separator membrane of any one of the preceding claims, wherein the separator membrane has less than 5% weight loss at a temperature of at least 200 C.

30. The separator membrane of any one of the preceding claims, wherein the separator membrane has less than 2% weight loss at a temperature of at least 200 C.

31. The separator membrane of any one of the preceding claims, wherein the separator membrane has less than 5% weight loss at a temperature of at least 200 C.

32. The separator membrane of any one of the preceding claims, wherein the polymer is a polyimide (PI).

33. The separator membrane of any one of the preceding claims, wherein the polymer is a polyimide (PI) having an aromatic structure in the backbone thereof.

34. The separator membrane of any one of the preceding claims, wherein the polymer is a polyimide (PI) comprising a radical of formula (Ia) and/or (Ib) in the backbone thereof:

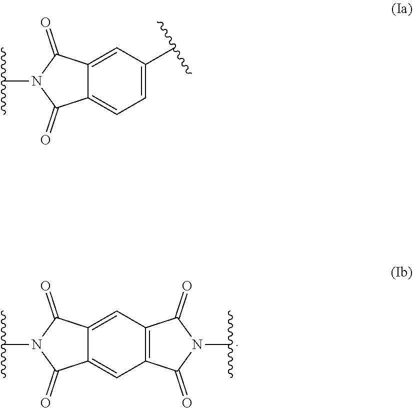

35. The separator membrane of any one of the preceding claims, wherein the polymer is a polyimide (PI) comprising a radical of formula (II) in the backbone thereof: 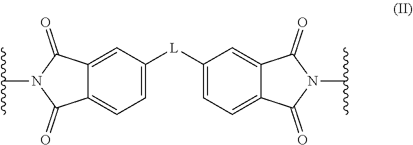
wherein each L is independently absent or carboxy.

36. The separator membrane of any one of the preceding claims, wherein the polymer is a polyimide (PI) comprising a radical of formula (III) in the backbone thereof:

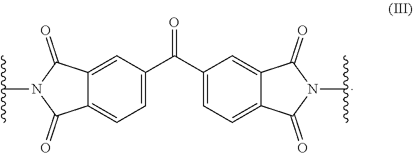

37. The separator membrane of any one of the preceding claims, wherein the polymer is a polyimide (PI) comprising a radical of formula (IVa) and/or (IVb): 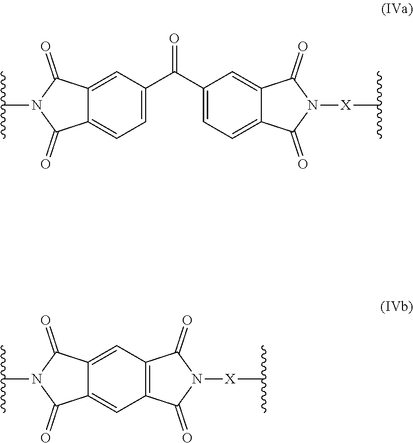
wherein each X is independently a hydrocarbon (e.g., comprising one or more aryl and one or more alkyl, such as alkyl, aryl, aryl-alkyl, aryl-alkyl-aryl, or other combination thereof).

38. The separator membrane of any one of the preceding claims, wherein the polymer is a polyimide (PI) comprising a radical of formula (Va) and/or formula (Vb): 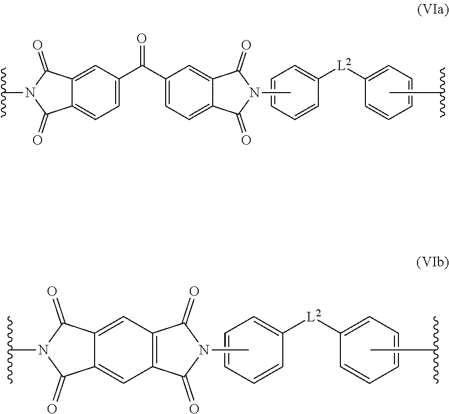
wherein each R¹ is independently H or alkyl.

39. The separator membrane of any one of the preceding claims, wherein the polymer is a polyimide (PI) comprising a radical of formula (VIa) and/or formula (VIb): 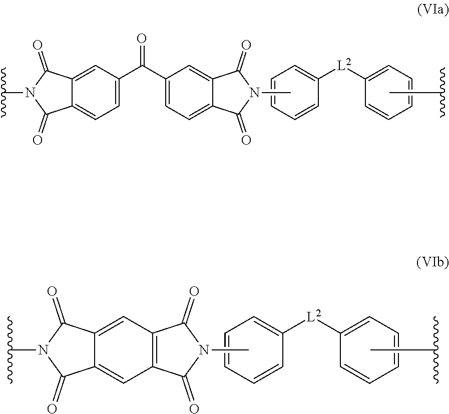
wherein each L2 is independently absent, alkyl, or carboxyl.

40. The separator membrane of any one of the preceding claims, wherein the polymer is a polyimide (PI) comprising (i) a radical of at least one of formula (Va) and/or formula (Vb), and (ii) a radical of at least one of formula (VIa) and/or formula (VIb).

41. The separator membrane of any one of the preceding claims, wherein at least 50% of the polymer of the first domain is covered with the continuous shell material.

42. The separator membrane of any one of the preceding claims, wherein at least 70% of the polymer of the first domain is covered with the continuous shell material.

43. The separator membrane of any one of the preceding claims, wherein at least 80% of the polymer of the first domain is covered with the continuous shell material.

44. The separator membrane of any one of the preceding claims, wherein at least 90% of the polymer of the first domain is covered with the continuous shell material.

45. The separator membrane of any one of the preceding claims, wherein at least 95% of the polymer of the first domain is covered with the continuous shell material.

46. The separator membrane of any one of the preceding claims, wherein the average thickness of the shell is about 50% or less of the overall average diameter of the shelled nanofiber segment(s).

47. The separator membrane of any one of the preceding claims, wherein the average thickness of the shell is about 30% or less of the overall average diameter.

48. The separator membrane of any one of the preceding claims, wherein the average thickness of the shell is about 20% or less of the overall average diameter.

49. The separator membrane of any one of the preceding claims, wherein the ceramic is a silicon based ceramic (e.g., SiCNO, SiCO, SiCN, SiNO, SiO ceramics).

50. The separator membrane of any one of the preceding claims, wherein the ceramic is a polymer derived ceramic (PDC) (e.g., ceramic derived from polysilazane, poly(organosilazanes), poly(organosilylcarbodiimides), poly(organosilsesquioxane), and poly(organosiloxanes)).

51. The separator membrane of any one of the preceding claims, wherein the ceramic is a ceramic derived from a poly(organosilsesquioxane).

52. The separator membrane of any one of the preceding claims, wherein the separator membrane has an average thickness of about 5 micron to about 15 micron.

53. The separator membrane of any one of the preceding claims, wherein the separator membrane has an average thickness of about 5 micron to about 10 micron.

54. The separator membrane of any one of the preceding claims, wherein the separator membrane has a thickness variation of less than 10%.

55. The separator membrane of any one of the preceding claims, wherein the separator membrane has a thickness variation of less than 5%.

56. The separator membrane of any one of the preceding claims, wherein the porous membrane has a pore size distribution d99 of about 1 micron or less.

57. The separator membrane of any one of the preceding claims, wherein the porous membrane has a pore size distribution d99.9 of about 1 micron or less.

58. The separator membrane of any one of the preceding claims, wherein the separator membrane shrinks less than 20% in both the longitudinal and transverse directions upon heating to at least 200 C.

59. The separator membrane of any one of the preceding claims, wherein the separator membrane shrinks less than 2% (e.g., in both the longitudinal and transverse directions) upon heating to at least 200 C.

60. The separator membrane of any one of the preceding claims, wherein the separator membrane has a strain of between −20% and +20% (shrinkage/expansion) at a temperature of at least 200 C and a controlled force of 0.001 N (e.g., in both longitudinal and transverse directions).

61. The separator membrane of any one of the preceding claims, wherein the separator membrane has a strain of between −2% and +2% at a temperature of at least 200 C and a controlled force of 0.001 N (e.g., in both longitudinal and transverse directions).

62. The separator membrane of any one of the preceding claims, wherein the separator membrane has an air permeability of at least 20 mL/s at a differential pressure of 35 pounds per square inch (psi).

63. An energy storage cell comprising a negative electrode, a positive electrode, and a separator membrane of any one of the preceding claims, the separator membrane being configured between the negative electrode and the positive electrode.

64. A lithium ion battery comprising a negative electrode, a positive electrode, and a separator membrane of any one of the preceding claims, the separator membrane being configured between the negative electrode and the positive electrode.

65. A nanofiber mat comprising one or more nanofibers comprising a continuous polymer matrix;
the nanofiber mat having a first membrane surface and a second membrane surface;
a first portion of the one or more nanofiber(s) being at and in proximity to) the first membrane surface, a second portion of the one or more nanofiber(s) being at and in proximity to the second membrane surface, and a third portion of the one or more nanofiber(s) being configured between the first and second membrane surfaces; and
the first portion of the one or more nanofiber(s) comprising one or more coated nanofiber segment(s), the one or more shelled nanofiber segment(s) comprising a continuous coating material, the continuous coating material comprising a ceramic precursor and/or a partially cured ceramic precursor, and the continuous matrix of polymer forming a continuous core material of the coated nanofiber segment(s).

66. The nanofiber mat of any one of the preceding claims, the nanofiber mat having a porosity of about 10% to about 70%.

67. The nanofiber mat of any one of the preceding claims, the nanofiber mat having an average thickness of about 1 micron to about 25 micron.

68. The nanofiber mat of any one of the preceding claims, wherein the first portion of the one or more nanofiber(s) comprises a plurality of nanofiber junctions, each nanofiber junction joining two or more intersecting nanofiber segment(s) of the first domain.

69. The nanofiber mat of any one of the preceding claims, wherein the nanofiber junction comprises a ceramic precursor or partially cured ceramic precursor (e.g., same as the ceramic precursor of the coating).

70. The nanofiber mat of any one of the preceding claims, wherein the ceramic precursor and/or partially cured ceramic precursor concentration of the first domain is higher than the ceramic precursor and/or partially cured ceramic precursor concentration (e.g., ceramic precursor and/or partially cured ceramic precursor weight relative to the polymer weight of the domain, or of the overall weight of the domain) of the second domain and/or the third domain.

71. The nanofiber mat of any one of the preceding claims, wherein the ceramic precursor and/or partially cured ceramic precursor concentration of the first domain is at least 1 percentage point by weight, relative to the polymer weight, higher than the ceramic precursor and/or partially cured ceramic precursor concentration of the second and/or third domain(s).

72. The nanofiber mat of any one of the preceding claims, wherein the ceramic precursor and/or partially cured ceramic precursor concentration of the first domain is at least 2 percentage point by weight, relative to the polymer weight, higher than the ceramic precursor and/or partially cured ceramic precursor concentration of the second and/or third domain(s).

73. The nanofiber mat of any one of the preceding claims, wherein the ceramic precursor and/or partially cured ceramic precursor concentration of the first domain is at least 5 percentage point by weight, relative to the polymer weight, higher than the ceramic precursor and/or partially cured ceramic precursor concentration of the second and/or third domain(s).

74. The nanofiber mat of any one of the preceding claims, wherein the first domain extends at least 0.1 micron into the mat.

75. The nanofiber mat of any one of the preceding claims, wherein the first domain extends at least 0.2 micron into the separator membrane.

76. The nanofiber mat of any one of the preceding claims, wherein the first domain extends at least 0.5 micron into the separator membrane.

77. The nanofiber mat of any one of the preceding claims, wherein the second portion of the one or more nanofiber(s) comprises one or more second coated nanofiber segment(s), the one or more second coated nanofiber segment(s) comprising a continuous coating material, the continuous coating material comprising a ceramic precursor and/or partially cured ceramic precursor, and the continuous matrix of polymer forming a continuous core material of the second coated nanofiber segment(s).

78. The nanofiber mat of any one of the preceding claims, the nanofiber mat having a thickness variation of less than 20%.

79. The nanofiber mat of any one of the preceding claims, the nanofiber mat comprising a plurality of pores therethrough, wherein fewer than 5% of the pores have a size of less than 1 micron (a pore distribution d95 of less than 1 micron).

80. The nanofiber mat of any one of the preceding claims, wherein the ceramic precursor and/or partially cured ceramic precursor of the continuous coating material constitutes about 1 wt. % to about 50 wt. % of the nanofiber mat.

81. The nanofiber mat of any one of the preceding claims, wherein the ceramic precursor and/or partially cured ceramic precursor of the continuous coating material constitutes about 3 wt. % to about 40 wt. % of the nanofiber mat.

82. The nanofiber mat of any one of the preceding claims, wherein the ceramic precursor and/or partially cured ceramic precursor of the continuous coating material constitutes about 5 wt. % to about 25 wt. % of the nanofiber mat.

83. The nanofiber mat of any one of the preceding claims, wherein the polymer of the continuous core material constitutes about 40 wt. % to about 99 wt. % of the nanofiber mat.

84. The nanofiber mat of any one of the preceding claims, wherein the polymer of the continuous core material constitutes about 60 wt. % to about 99 wt. % of the nanofiber mat.

85. The nanofiber mat of any one of the preceding claims, wherein the polymer of the continuous core material is a non-flammable polymer.

86. The nanofiber mat of any one of the preceding claims, wherein the polymer of the continuous core materials has a limiting oxygen index (LOI) of at least 21%.

87. The nanofiber mat of any one of the preceding claims, wherein the polymer of the continuous core materials has a limiting oxygen index (LOI) of at least 25%.

88. The nanofiber mat of any one of the preceding claims, wherein the polymer of the continuous core materials has a limiting oxygen index (LOI) of at least 30%.

89. The nanofiber mat of any one of the preceding claims, wherein the polymer of the continuous core materials has a limiting oxygen index (LOI) of at least 35%.

90. The nanofiber mat of any one of the preceding claims, wherein the polymer of the continuous core material is a thermally-stable polymer.

91. The nanofiber mat of any one of the preceding claims, wherein the polymer is a polyimide (PI).

92. The nanofiber mat of any one of the preceding claims, wherein the polymer is a polyimide (PI) having an aromatic structure in the backbone.

93. The nanofiber mat of any one of the preceding claims, wherein the polymer is a polyimide (PI) comprising a radical of formula (Ia) and/or (Ib) in the backbone thereof:

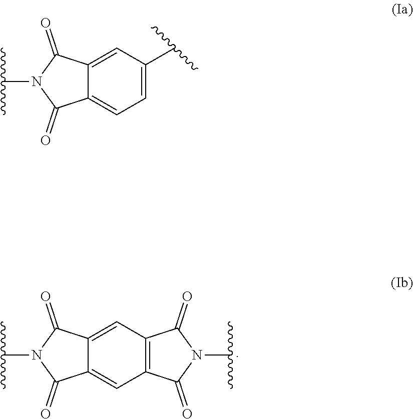

94. The nanofiber mat of any one of the preceding claims, wherein the polymer is a polyimide (PI) comprising a radical of formula (II) in the backbone thereof: 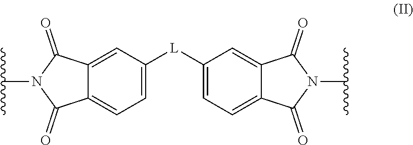
wherein each L is independently absent or carboxy.

95. The nanofiber mat of any one of the preceding claims, wherein the polymer is a polyimide (PI) comprising a radical of formula (III) in the backbone thereof:

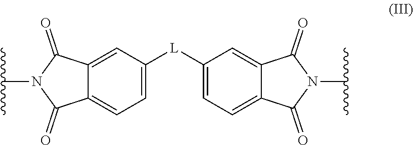

96. The nanofiber mat of any one of the preceding claims, wherein the polymer is a polyimide (PI) comprising a monomeric residue of formula (IVa) and/or (IVb): 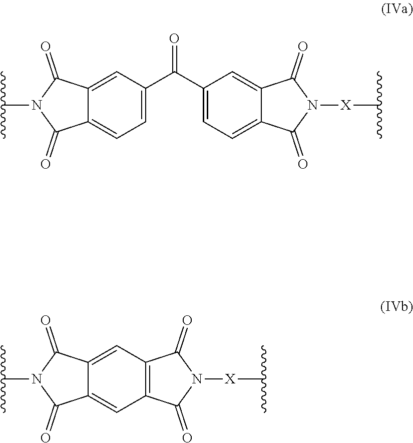
wherein each X is independently a hydrocarbon (e.g., comprising one or more aryl and one or more alkyl, such as alkyl, aryl, aryl-alkyl, aryl-alkyl-aryl, or other combination thereof).

97. The nanofiber mat of any one of the preceding claims, wherein the polymer is a polyimide (PI) comprising a monomeric residue of formula (Va) and/or formula (Vb): 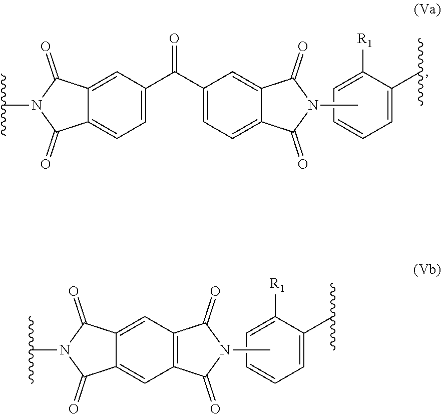
wherein each R¹ is independently H or alkyl.

98. The nanofiber mat of any one of the preceding claims, wherein the polymer is a polyimide (PI) comprising a monomeric residue of formula (VIa) and/or formula (VIb): 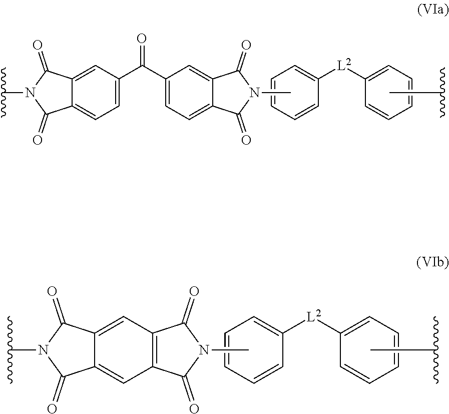
wherein each L2 is independently absent, alkyl, or carboxyl.

99. The nanofiber mat of any one of the preceding claims, wherein the polymer is a polyimide (PI) comprising (i) a monomeric residue of at least one of formula (Va) and/or formula (Vb), and (ii) a monomeric residue of at least one of formula (VIa) and/or formula (VIb).

100. The nanofiber mat of any one of the preceding claims, wherein at least 50% of the polymer core material is covered with the continuous coating material.

101. The nanofiber mat of any one of the preceding claims, wherein at least 70% of the polymer core material is covered with the continuous coating material.

102. The nanofiber mat of any one of the preceding claims, wherein at least 80% of the polymer core material is covered with the continuous coating material.

103. The nanofiber mat of any one of the preceding claims, wherein at least 90% of the polymer core material is covered with the continuous coating material.

104. The nanofiber mat of any one of the preceding claims, wherein at least 95% of the polymer core material is covered with the continuous coating material.

105. The nanofiber mat of any one of the preceding claims, wherein the average thickness of the coating is about 30% or less of the average diameter continuous core materials.

106. The nanofiber mat of any one of the preceding claims, wherein the average thickness of the coating is about 20% or less of the average diameter continuous core materials.

107. The nanofiber mat of any one of the preceding claims, wherein the average thickness of the coating is about 10% or less of the average diameter continuous core materials.

108. The nanofiber mat of any one of the preceding claims, wherein the ceramic precursor is a polymer derived ceramic (PDC) precursor (e.g., ceramic derived from polysilazane, poly(organosilazanes), poly(organosilylcarbodiimides), poly(organosilsesquioxane), and poly(organosiloxanes)).

109. The nanofiber mat of any one of the preceding claims, wherein the ceramic precursor is a poly(organosilsesquioxane).

110. The nanofiber mat of any one of the preceding claims, wherein the mat has an average thickness of about 5 micron to about 15 micron.

111. The nanofiber mat of any one of the preceding claims, wherein the mat has an average thickness of about 5 micron to about 10 micron.

112. The nanofiber mat of any one of the preceding claims, wherein the mat has a thickness variation of less than 10%.

113. The nanofiber mat of any one of the preceding claims, wherein the mat has a thickness variation of less than 5%.

114. The nanofiber mat of any one of the preceding claims, wherein the porous membrane has a pore size distribution d99 of about 1 micron or less.

115. The nanofiber mat of any one of the preceding claims, wherein the porous membrane has a pore size distribution d99.9 of about 1 micron or less.

116. The nanofiber mat of any one of the preceding claims, wherein the separator membrane shrinks less than 20% in both the longitudinal and transverse directions upon heating to at least 200 C.

117. The nanofiber mat of any one of the preceding claims, wherein the separator membrane shrinks less than 10% (e.g., in both the longitudinal and transverse directions) upon heating to at least 200 C.

118. A process for manufacturing a thermally stable, flame-resistant polymer-ceramic battery separator membrane, the process comprising:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
providing the fluid stock to a first inlet of a first conduit of a nozzle apparatus, the first conduit being enclosed along the length of the first conduit by a first wall having an interior surface and an exterior surface, the first conduit having a first outlet;
providing a gas to a second inlet of a second conduit of the nozzle apparatus, the second conduit being enclosed along the length of the second conduit by a second wall having an interior surface, the second conduit having a second outlet, and at least a portion of the second conduit being positioned along and/or in at least partially surrounding relation to the first conduit; whereby a high velocity gas is provided at the second outlet, the high velocity gas having a velocity of at least 0.05 m/s;
providing a voltage to the nozzle apparatus;
collecting a ceramic precursor composition on the nanofiber mat (e.g., forming precursor membrane comprising nanofiber mat coated with ceramic precursor, which may or may not be partially cured);
thermally treating the composition; and
calendering the composition.

119. A process for manufacturing a thermally stable, flame-resistant polymer-ceramic battery separator membrane, the process comprising:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
electrostatically charging the fluid stock;
injecting the fluid stock into a gas stream (e.g., using a nozzle apparatus configured to inject the fluid stock into the gas stream), the gas stream having a velocity of at least 0.05 m/s;
collecting a ceramic precursor composition on the nanofiber mat (e.g., forming precursor membrane comprising nanofiber mat coated with ceramic precursor, which may or may not be partially cured);
thermally treating the nanofiber mat (e.g., precursor membrane); and
calendering the nanofiber mat (e.g., precursor membrane).

120. A process for manufacturing a thermally stable, flame-resistant polymer-ceramic battery separator membrane, the process comprising:
providing a nanofiber mat, the nanofiber mat comprising one or more nanofiber, the one or more nanofiber each comprising a continuous matrix of (e.g., thermally stable, non-flammable) polymer;
providing a fluid stock, the fluid stock comprising a liquid medium, and a ceramic precursor;
electrostatically charging the fluid stock;
injecting the fluid stock into a gas stream (e.g., using a nozzle apparatus configured to inject the fluid stock into the gas stream), the gas stream having a velocity of at least 0.05 m/s;
collecting a coating composition on the nanofiber mat forming a coated nanofiber mat (e.g., precursor membrane);
thermally treating the coated nanofiber mat; and
calendering the coated nanofiber mat.

121. The process of any one of the preceding claims, wherein the nozzle is an electrospray nozzle.

122. The process of any one of the preceding claims, wherein upon ejection of the fluid stock from the first outlet, an aerosol or plume is provided, the aerosol or plume comprising a plurality of plume particles, the plurality of plume particles within d/4 of the substrate having an average dimension of about 1 micron or less, wherein d is the shortest distance between the first outlet of the nozzle and the substrate.

123. The process of any one of the preceding claims, wherein upon ejection of the fluid stock from the first outlet, an aerosol or plume is provided, the aerosol or plume comprising a plurality of plume particles, the plurality of plume particles within d/4 of the substrate having an average dimension of about 0.5 micron or less, wherein d is the average distance between the first outlet of the nozzle and the substrate.

124. The process of any one of the preceding claims, wherein the nanofiber mat surface is in opposing relation to the nozzle (e.g., first and second outlets thereof).

125. The process of any one of the preceding claims, wherein the nanofiber mat is optionally positioned on a substrate, and the nanofiber mat or the substrate to which the nanofiber mat is configured is associated with or affixed to a roll-to-roll conveyor system.

126. The process of any one of the preceding claims, wherein the conduit gap (e.g., the average distance between the inner and outer wall of the second conduit, such as on a line drawn from the center of the first conduit and extending outward through the second conduit that at least partially surrounds the first conduit) is about 0.05 mm to about 30 mm.

127. The process of any one of the preceding claims, wherein the conduit gap is about 0.05 mm to about 20 mm.

128. The process of any one of the preceding claims, wherein the conduit gap is about 0.1 mm to about 10 mm.

129. The process of any one of the preceding claims, wherein the inner surface of the outer walls defining the first and second conduit are within 15 degrees of parallel of one another for at least a portion of the length of the first and second conduits ((e.g., the length of the portion of the nozzle wherein the first and second conduits are within 15 degrees of parallel of one another being the conduit overlap length).

130. The process of any one of the preceding claims, wherein the inner surface of the outer walls defining the first and second conduit are within 5 degrees of parallel of one another for at least a portion of the length of the first and second conduits (e.g., the length of the portion of the nozzle wherein the first and second conduits are within 5 degrees of parallel of one another being the conduit overlap length).

131. The process of any one of the preceding claims, wherein the ratio of the conduit overlap length to the first diameter is about 1 or more (e.g., about 2 or more, about 3 or more, about 5 or more, about 1 to about 10).

132. The process of any one of the preceding claims, wherein the polymer has a limiting oxygen index (LOI) of at least 21%.

133. The process of any one of the preceding claims, wherein the polymer has a limiting oxygen index (LOI) of at least 25%.

134. The process of any one of the preceding claims, wherein the polymer has a limiting oxygen index (LOI) of at least 30%.

135. The process of any one of the preceding claims, wherein the polymer has a limiting oxygen index (LOI) of at least 35%.

136. The process of any one of the preceding claims, wherein the polymer is thermally stable (e.g., having less than 5 wt. % loss, less than 3 wt. % loss, or less than 1 wt. % loss at 200 C (e.g., held for at least 1 minute)).

137. The process of any one of the preceding claims, wherein the polymer is a polyimide (PI).

138. The process of any one of the preceding claims, wherein the polymer is a polyimide (PI) having an aromatic structure in the backbone thereof.

139. The process of any one of the preceding claims, wherein the polymer is a polyimide (PI) comprising a radical of formula (Ia) and/or (Ib) in the backbone thereof:

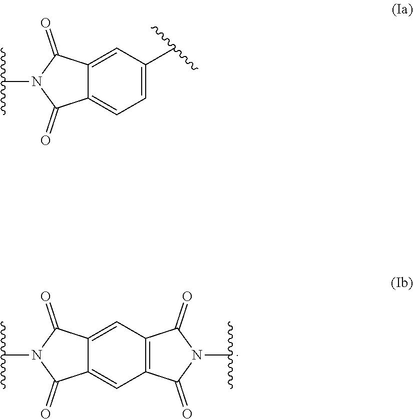

140. The process of any one of the preceding claims, wherein the polymer is a polyimide (PI) comprising a radical of formula (II) in the backbone thereof: 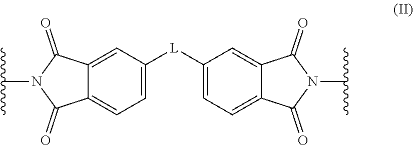
wherein each L is independently absent or carboxy.

141. The process of any one of the preceding claims, wherein the polymer is a polyimide (PI) comprising a radical of formula (III) in the backbone thereof:

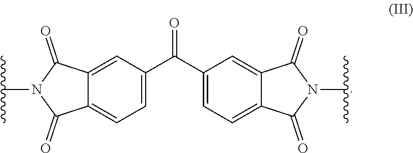

142. The process of any one of the preceding claims, wherein the polymer is a polyimide (PI) comprising a radical of formula (IVa) and/or (IVb): 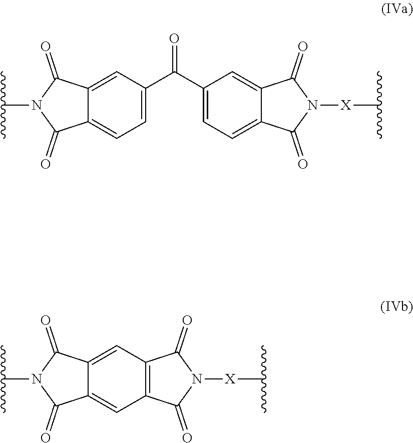
wherein each X is independently a hydrocarbon (e.g., comprising one or more aryl and one or more alkyl, such as alkyl, aryl, aryl-alkyl, aryl-alkyl-aryl, or other combination thereof).

143. The process of any one of the preceding claims, wherein the polymer is a polyimide (PI) comprising a radical of formula (Va) and/or formula (Vb): 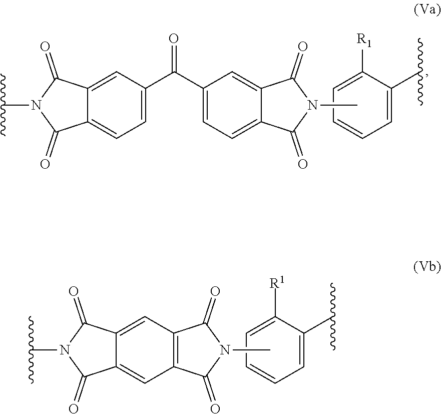
wherein each R¹ is independently H or alkyl.

144. The process of any one of the preceding claims, wherein the polymer is a polyimide (PI) comprising a radical of formula (VIa) and/or formula (VIb): 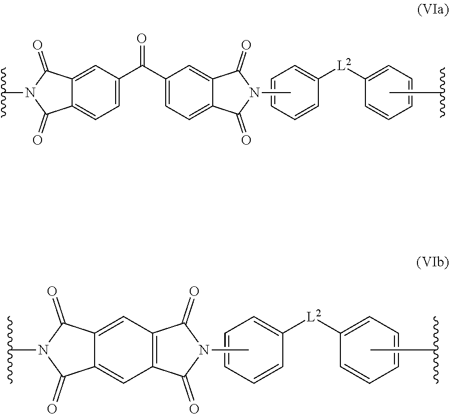
wherein each L2 is independently absent, alkyl, or carboxyl.

145. The process of any one of the preceding claims, wherein the polymer is a polyimide (PI) comprising (i) a radical of at least one of formula (Va) and/or formula (Vb), and (ii) a radical of at least one of formula (VIa) and/or formula (VIb).

146. The process of any one of the preceding claims, wherein ceramic precursor in an amount of about 1 wt. % to about 50 wt. %, relative to the combined weight of precursor and nanofiber mat, is deposited on the nanofiber mat.

147. The process of any one of the preceding claims, wherein ceramic precursor in an amount of about 5 wt. % to about 40 wt. %, relative to the combined weight of precursor and nanofiber mat, is deposited on the nanofiber mat.

148. The process of any one of the preceding claims, wherein the ceramic is a silicon based ceramic (e.g., SiCNO, SiCO, SiCN, SiNO, SiO ceramics).

149. The process of any one of the preceding claims, wherein the ceramic is a polymer derived ceramic (PDC) (e.g., ceramic derived from polysilazane, poly(organosilazanes), poly(organosilylcarbodiimides), poly(organosilsesquioxane), and poly(organosiloxanes)).

150. The process of any one of the preceding claims, wherein the ceramic is a ceramic derived from a poly(organosilsesquioxane).

151. The process of any one of the preceding claims, wherein about 0.1 wt. % to about 10 wt. % (e.g., about 1 wt. % to about 5 wt. %) of the collected composition is the liquid medium.

152. The process of any one of the preceding claims, wherein the membrane is a battery separator.

153. A nanofiber mat comprising a nanofiber;
the nanofiber comprising a polymer in an amount of about 88 wt. % to about 95 wt. % and a ceramic in an amount of about 5 wt. % to about 12 wt. %, the polymer being a polyimide and the ceramic being a ceramic derived from a polysilizane;
the nanofiber comprising a core and a ceramic shell, the ceramic shell comprising a portion of the nanofiber ceramic and covering at least 50% of the nanofiber core (or surface thereof);
the nanofiber core comprising the polymer and a second portion of the nanofiber ceramic; and
the battery separator having an average thickness of about 5 micron to about 25 micron.

154. The nanofiber mat of claim 153, wherein the polyimide is a polyimide of any one of the preceding claims.

155. The nanofiber mat of either one of claim 153 or 154, wherein the polysilizane is an organopolysilizane.

156. The nanofiber mat of any one of claims 153-155, wherein the nanofiber comprises a polymer in an amount of about 90 wt. % to about 95 wt. % and a ceramic in an amount of about 5 wt. % to about 10 wt. %.

157. The nanofiber mat of claim 156, wherein the nanofiber comprises a polymer in an amount of about 91 wt. % to about 93 wt. % and a ceramic in an amount of about 7 wt. % to about 9 wt. %.

158. The nanofiber mat of any one of claims 153-157, comprising a plurality of the nanofibers.

159. The nanofiber mat of any one of claims 153-158, wherein the core comprises a continuous polymer matrix (e.g., comprising the polymer).

160. The nanofiber mat of any one of claims 153-159, wherein the core comprises a continuous ceramic matrix (e.g., comprising the second portion of ceramic).

161. The nanofiber mat of claim 160, wherein the core comprises a co-continuous matrix of ceramic and polymer.

162. A battery separator comprising a porous membrane comprising the nanofiber mat of any one of claims 153-161.

163. The battery separator of claim 162 further comprising the characteristics of any one of the preceding claims.

164. A process for manufacturing a nanofiber mat (or battery separator comprising the same), the process comprising:
providing a fluid stock, the fluid stock comprising a liquid medium and a polyimide and a ceramic precursor, the ceramic precursor being an organopolysilizane, the polyimide and organopolysilizane being present in a weight ratio of polyimide to organopolysilizane of about 90:10 to about 95:5;
providing the fluid stock to a first inlet of a first conduit of a nozzle apparatus, the first conduit being enclosed along the length of the first conduit by a first wall having an interior surface and an exterior surface, the first conduit having a first outlet;
providing a gas to a second inlet of a second conduit of the nozzle apparatus, the second conduit being enclosed along the length of the second conduit by a second wall having an interior surface, the second conduit having a second outlet, and at least a portion of the second conduit being positioned along and/or in at least partially surrounding relation to the first conduit; whereby a high velocity gas is provided at the second outlet, the high velocity gas having a velocity of at least 0.05 m/s; and
providing a voltage to the nozzle apparatus.

165. The process of claim 164, wherein the polyimide is present in the fluid stock in a concentration sufficient to produce a jet or fiber upon expulsion of the jet from nozzle apparatus (e.g., at least 5 wt. %, at least 6 wt. %, at least 8 wt. %, or at least 10 wt. %).

166. The process of either one of claim 164 or 165, wherein the weight ratio of polyimide to organopolysilizane is about 92:8 to about 96:4.

167. The process of any one of claims 164-166, wherein the polymide is the polyimide of any one of the preceding claims.

168. The process of any one of claims 164-167, wherein the nanofiber mat is a nanofiber mat of any one of claims 153-163.
